(19) United States
(12) Patent Application Publication
(10) Pub. No.: US 2025/0384483 A1
(43) Pub. Date: Dec. 18, 2025

(54) FUTURE PRESENT

(71) Applicants: Nahum Eshel, Ramat Gan (IL); Josef Eshel, Ramat Gan (IL); Odelia Elkabets, Tel Aviv (IL)

(72) Inventors: Nahum Eshel, Ramat Gan (IL); Josef Eshel, Ramat Gan (IL); Odelia Elkabets, Tel Aviv (IL)

(21) Appl. No.: 19/317,220

(22) Filed: Sep. 3, 2025

Related U.S. Application Data
(63) Continuation-in-part of application No. PCT/IB2024/052497, filed on Mar. 14, 2024.
(60) Provisional application No. 63/451,974, filed on Mar. 14, 2023.
(60) Provisional application No. 63/692,195, filed on Sep. 9, 2024.

(51) Int. Cl. G06Q 40/02; G06Q 40/06

(52) U.S. Cl. CPC G06Q 40/0225; G06Q 40/0631

(57) ABSTRACT

A method and system for financial services, intergenerational savings, trust management, future inheritance planning, and the use of artificial intelligence in conditional asset management facilitate the generation and protection of multi-generational wealth.

### RELATED APPLICATIONS

This application is a Continuation in Part of International patent application PCT/IB2024/052497 filed on 14 Mar. 2024 which claims the benefit of priority under 35 USC § 119 (e) of U.S. Provisional Patent Application No. 63/451,974 filed on 14 Mar. 2023. In addition, the current application claims the benefit of priority under 35 USC § 119 (e) of U.S. Provisional Patent Application No. 63/692,195 filed on 9 Sep. 2024, the contents of which are incorporated herein by reference in their entirety.

### FIELD AND BACKGROUND OF THE INVENTION

The present invention, in some embodiments thereof, relates to a method and system for legacy savings and, more particularly, but not exclusively, for generational savings.

Most savings mechanisms are built on the ability to increase initial wealth by utilizing the principle of compound interest. The process of increasing wealth consists of three elements. (1) The initially invested sum (principal), (2) the rate of return obtainable from that investment, and (3) the duration of the investment period.

Generally, a savings fund or pension cannot be continued and/or transferred and maintained from one generation to another generation. Investment, pension, and savings funds are limited in time, e.g., until the client retires, or until death.

Therefore, there is a need for a system and method for multi-generational savings and/or a legacy savings.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1 is a chart illustrating the power of compound interest, in accordance with some embodiments.

FIG. 2 is a graph of long-term trajectories of investments against a logarithmic scale, in accordance with some embodiments.

FIG. 3 is a table illustrating the effect of different rates of interest, in accordance with some embodiments

FIG. 4 illustrates a variety of investment results calculated according to interest rates between 4% and 10% according to investment terms of 25 years, 30 years and 40 years and 50 years, in accordance with some embodiments

FIG. 5 illustrates the growth over a 90-year investment period at 10-year intervals, in accordance with some embodiments.

FIG. 6 describes the development of savings value over a 150-year savings period, given a yield of 5%, in accordance with some embodiments.

FIG. 7 describes the development of savings value over a 150-year savings period, given a yield of 7%, in accordance with some embodiments.

FIG. 8 describes the development of savings value over a 150-year savings period, given a yield of 10%, in accordance with some embodiments.

FIG. 9 is a table showing an exemplary doubling ladder, further emphasizing the power of doublings, as time passes, the amount of money grows exponentially, in accordance with some embodiments.

FIG. 10 is a graph illustrating what interest rate would be necessary to reach 10 doublings in a normal lifespan, in accordance with some embodiments.

FIG. 11 is a table illustrating a reasonable expectation of interest rates based on data from 1985-2019, using various available financial instruments, in accordance with some embodiments.

FIG. 12 is a table illustrating the S&P 500 actual return index by decade, in accordance with some embodiments.

FIG. 13 is a flow chart of a method of use, in accordance with some embodiments of the invention.

FIGS. 14A and 14B are tables illustrating the advantage of the system, in accordance with some embodiments.

FIG. 15 is a table illustrating various investment plans by investing $1,000 for between 100-200 years at various interest rates to show the return provided by compound interest on the initial investment, in accordance with some embodiments.

FIG. 16 is a table illustrating the comparison between a conventional retirement plan verses a one-time investment e.g., at birth, at the same interest rate, in accordance with some embodiments.

FIG. 17 is a table of a multi-generational investments plan based on an initial small investment, in accordance with some embodiments.

FIG. 18A is a table illustration of creation of a retirement fund by investing one or more “locked” investments at the beginning of a person's career or at birth, in accordance with some embodiments.

FIG. 18B illustrates a “1,000×” savings plan, in accordance with an embodiment of the current invention.

FIG. 19 is a block diagram of an investment fund, in accordance with an embodiment of the current invention.

FIG. 20A is a flow chart of a method of creating a retirement account, in accordance with some embodiments of the invention.

FIG. 20B is a flow chart of a method of use, in accordance with some embodiments of the invention

FIGS. 21A-21B are flow diagrams of a method of investing over an extended period, in accordance with some embodiments of the invention.

FIGS. 22A-22C are schematic illustrations of various investment plans and/or instruments, in accordance with embodiments of the current invention.

FIG. 23 is a flow chart of a method which may enable long-term intergenerational wealth accumulation and/or distribution, in accordance with some embodiments.

FIG. 24 is a block diagram illustrating a system for multi-generational wealth creation, in accordance with some embodiments.

FIG. 25 is a flow diagram 100 of the instant method, in accordance with some embodiments

FIG. 26 is a high-level diagram of specific components of the instant system, in accordance with some embodiments.

FIG. 27 is a pictorial flow diagram 300 indicating the high-level components and aspects of the present system and method, in accordance with some embodiments.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include investing an initial investment. The method may also include defining at least one beneficiary. The method may furthermore include naming an emissary, e.g., trustee. The method may in addition include locking the investment in a closed investment instrument. The method may moreover include accruing compound interest. The method may also include tracking the investment's progress. The method may furthermore include withdrawing a portion of the accrued funds from the investment instrument after fulfilling a pre-defined parameter. The method may in addition include distributing the withdrawn funds to the defined beneficiary. The method may moreover include reinvesting a portion of the accrued funds in a closed investment instrument for an additional investment cycle. The method may moreover include continuing the investment with a portion of the accrued funds for an additional investment cycle.

Implementations may include one or more of the following features. The method where defining the beneficiary includes selecting one or more of a descendant of the initial investor, an individual designated by the initial investor, an organization, or a purpose. The method where naming the emissary includes selecting one or more emissaries, and/or trustees and/or executors from an organization, e.g., a law office, a charitable fund, an investment firm, an automated system, or an artificial intelligence (AI) model. The method where the accruing compound interest is achieved through a diversified growth-oriented portfolio. The method where the pre-defined parameter includes reaching a pre-defined growth milestone, a pre-defined number of doublings of the initial investment, a pre-defined amount, a pre-defined duration of investment, a raw return percentage, emergency circumstances, extenuating circumstances, or a combination thereof. The method may include designating a new list of beneficiaries for the additional investment cycle. The method may include entrusting a third party to manage the investment according to pre-defined rules, e.g., emissary, trustee, executor, etc. The method may include enforcing a maximum management fee cap. The method may include repeating the method by each generation, gradually building family capital over multiple generations.

In one general aspect, investment system may include an investment module configured to invest an initial investment in index-tracking funds or a diversified portfolio. Investment system may also include a conditional mechanism configured to determine if a pre-defined parameter has been fulfilled. System may furthermore include an executor and/or emissary module configured to enforce the conditional mechanism. System may in addition include a beneficiary identification mechanism configured to identify legal heirs or designated individuals when the pre-defined parameter has been fulfilled.

Implementations may include one or more of the following features. System where the pre-defined parameter includes reaching a pre-defined growth milestone, a pre-defined number of doublings of the initial investment, a pre-defined amount, a pre-defined duration of investment, a raw return percentage, emergency circumstances, extenuating circumstances, or a combination thereof. System where the beneficiary includes one or more of a descendant of the initial investor, an individual designated by the initial investor, an organization, or a purpose. System where the one or more emissaries, and/or trustees and/or executors is selected from one or more of an organization, a law office, a charitable fund, an investment firm, an automated system, or an artificial intelligence (AI) model. System may include legal safeguards configured to ensure that the system is maintained beyond the death of the initial investor. System where the initial investment is made at a child's birth and/or prior to a child's birth, and is intended to be accessed by that individual or their descendants in the future. System where the system is a pre-structured multi-generational plan, where each generation receives part of the fund and leaves the remainder in savings for the next generation and/or reinvests the rest for the next generation, thereby forming a permanent wealth loop.

In one general aspect, non-transitory computer-readable medium storing computer-executable instructions may include train a machine learning model or artificial intelligence (AI) using financial datasets. Non-transitory computer-readable medium storing computer-executable instructions may also include receive parameter values via a user interface. Instructions may furthermore include generate a savings plan for a short or long-term savings instrument based on the provided parameter values, the savings plan being driven by the machine learning engine that matches the provided parameter values to an existing savings plan from a Plans Database or synthesizes a customized savings plan.

Implementations may include one or more of the following features. Non-transitory computer-readable medium where the savings plan is implemented by a financial manager module that creates a savings fund. Non-transitory computer-readable medium where the savings plan includes a disbursement schedule based at least in part on milestones, the disbursement schedule being implemented by the financial manager module by disbursing funds to beneficiaries of the savings plan. Non-transitory computer-readable medium where the milestones include a predetermined amount of relative wealth accrued, a birth or death of a beneficiary, or a predetermined number of times the value of the wealth accrued in the savings fund is doubled.

In one general aspect, computer-implemented method may include providing a non-transitory computer readable medium storing computer-executable instructions that configured to be executed by a processor. Computer-implemented method may also include training a machine learning model of a machine learning engine using financial datasets. The method may furthermore include providing parameter values to a Savings Plan Creator via an user interface; generating, by the Savings Plan Creator, a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan.

Implementations may include one or more of the following features. Computer-implemented method may include: creating a savings fund according to the savings plan. Computer-implemented method may include: managing the savings plan by a financial manager module that is driven by the machine learning engine.

In one general aspect, system may include a first sub-system configured to receive an initial investment amount from a user. System may also include a second sub-system configured to lock the initial investment amount for a predetermined period, preventing early withdrawal except under predefined conditions. The investment amount and/or investment period are controlled by the emissary. The system may furthermore include a third sub-system configured to accrue compound interest on the initial investment amount over the predetermined period. System may in addition include a fourth sub-system configured to determine when the initial investment amount has doubled a predefined number of times. System may moreover include a fifth sub-system configured to facilitate withdrawal of a portion of the accrued wealth upon meeting the predefined conditions or a predefined number of doublings. System may also include a sixth sub-system configured to monitor the remaining portion of the investment and/or to reinvest any remaining portion of the accrued wealth for an additional investment period. System may furthermore include a seventh sub-system configured to manage the investment and reinvestment process using an artificial intelligence (AI) algorithm. System may in addition include an eighth sub-system configured to distribute funds to beneficiaries based on a disbursement schedule driven by the AI algorithm and predefined milestones.

Other embodiments may include corresponding computer systems, apparatus, and computer programs recorded on one or more computer storage devices, each configured to perform the actions of the methods.

Implementations may include one or more of the following features. System where the first sub-system is further configured to receive the initial investment amount at any time, including at the birth of a child, marriage, or after a windfall. System where the predefined conditions for early withdrawal include emergency circumstances such as medical emergencies, ongoing medical treatment, bankruptcy, war, terror attacks, or purchasing a house. System where the AI algorithm is configured to continually train on current financial data received from financial institutions to optimize the investment strategy. System where the disbursement schedule includes milestones such as a predetermined amount of relative wealth accrued, a birth or death of a beneficiary, or a predetermined number of times the value of the wealth accrued in the savings fund is doubled. System where the sixth sub-system is further configured to allow each generation to withdraw a percentage of the investments and reinvest or maintain a percentage of the investments for future generations. System where the AI algorithm manages the savings fund by making decisions including where to invest, how much to invest, when to withdraw funds from investments, and combinations thereof. Optionally, the AI algorithm may make suggestions to a professional account manager. System where the seventh sub-system includes a non-transitory computer-readable medium storing computer-executable instructions that, when executed by a processor, cause the AI algorithm to train a machine learning model using financial datasets to generate and manage the savings plan.

In one general aspect, the method may include receiving an initial investment from a user. The method may also include locking the initial investment in a financial account for a predetermined period of time. The method may furthermore include accruing compound interest on the initial investment during the predetermined period of time. The method may in addition include determining if predefined conditions for early withdrawal are met, where the predefined conditions include emergency circumstances. The method may moreover include reinvesting the compound interest accrued on the initial investment. The method may also include preventing access to the accrued wealth until the occurrence of predefined milestones, where the predefined milestones include at least one of the following: a predetermined amount of interest accrued, a predetermined amount of money accrued, a predetermined amount of time elapsed, or a predetermined number of doublings of the investment. The method may furthermore include upon reaching one of the predefined milestones, disbursing a portion of the accrued wealth to designated beneficiaries while reinvesting the remaining portion for future growth. The method may in addition include managing the financial account using an artificial intelligence (AI) algorithm, where the AI algorithm is trained on financial datasets and continually updated with current financial data to optimize investment decisions. Other embodiments of this aspect include corresponding computer systems, apparatus, and computer programs recorded on one or more computer storage devices, each configured to perform the actions of the methods.

Implementations may include one or more of the following features. The method may include: allowing the user to define the initial investment amount, where the initial investment amount can be a single lump sum or a series of periodic deposits. The method where the predefined conditions for early withdrawal include at least one of the following: medical emergency, ongoing medical treatment, bankruptcy, war, terror attacks, or purchasing a house. The method may include: designating a third party to oversee the management of the financial account, where the third party can be an emissary, executor, trustee, steward, financial institution, or an AI algorithm. The method may include: consulting with the user or a descendant thereof to define the amount to withdraw and/or to redefine conditions for future withdrawal. The method where the AI algorithm includes a machine learning engine that generates a savings plan based on provided parameter values, the savings plan including a disbursement schedule based on milestones. The method may include: preventing early withdrawal based on a contract and/or escrow agreement. The method where the financial account is managed by the AI algorithm, and the management includes making decisions on where to invest, how much to invest, and when to withdraw funds from investments.

Implementations of the described techniques may include hardware, a method or process, or a computer tangible medium.

### DESCRIPTION OF SPECIFIC EMBODIMENTS OF THE INVENTION

The present invention, in some embodiments thereof, relates to a method and system for legacy savings and, more particularly, but not exclusively, for generational savings.

### Overview

An aspect of some embodiments of the current invention relates to a method and system for legacy savings. Optionally, the system and method may relate to financial services, intergenerational savings, trust management, future inheritance planning, and the use of artificial intelligence in conditional asset management. Optionally, the system and method may be multi-generational. Some embodiments relate to financial savings for use by a user in their lifetime and/or for the use of one or more generations thereafter. Optionally, the system may relate to a savings fund that can be continued and/or transferred and/or maintained from one generation to another generation, e.g., after a user and/or one or more generations of the users' decedents retire or pass away. Optionally, the system and method may harness time and/or discipline to build exponential intergenerational wealth. Optionally, the system and method may facilitate protection of multi-generational wealth.

The method, system, and/or product disclosed herein are intended to provide customers worldwide with a product/system for continuous, rolling and/or daisy chained financial savings which is designed for short, medium and/or long periods of time with interest and/or returns that change and increase as time passes, according to the pre-defined and/or pre-selected savings plan. The system may be based on the ability to increase wealth by utilizing the principle of compound interest. The process of increasing wealth includes interaction between three elements. (1) The initially invested sum (principal), (2) the rate of return obtainable from that investment, and (3) the duration of the investment period.

According to some embodiments, the initial investment amount may be small, e.g., $10, $100, $1,000, $10,000, etc., preferably not less than $500. Optionally, the initial investment may be made at any time, e.g., birth of a child, marriage, after a windfall, large payout, etc. Optionally, the initial investment may be a single investment. Optionally, the initial investment may be a series of deposits, e.g., monthly deposits, quarterly deposits, etc. Optionally, the series of deposits may be discontinued after a pre-determined amount of time and/or when a pre-determined amount of money has been deposited. Optionally, the series of deposits may be discontinued by the user at any point in time. Additionally, while compounded interest creates exponential growth and people are generally not aware of this potential, and conventional investment instruments do not encourage taking full advantage of this potential. Many people lack awareness and/or discipline to take advantage of the potential of compound interest over a long period as long as the money, is not withdrawn, and the interest is allowed to accrue. Optionally, the bulk of the profit may be generated after the money has been invested for a long period.

According to some embodiments an investment instrument may include a modest initial investment amount. Optionally, compound interest may provide exponential growth over a long period. Optionally, the compound interest may be reinvested. Optionally, the compound interest may be allowed to accrue. Optionally, the doubling time of the investment may provide a measure of the accrued compound interest. Optionally, the accrued wealth may not be accessed until a pre-determined amount of interest has been accrued. Optionally, the accrued wealth may not be accessed until a pre-determined amount of money has been accrued. Optionally, the accrued wealth may not be accessed until a pre-determined amount of time has passed. Optionally, the accrued wealth may not be accessed until a pre-determined number of doublings has taken place.

According to some embodiments, the system may facilitate the accrual of wealth from a one-time investment of a small sum over a long period of time, instead of multiple deposits of small amounts. Optionally, the length of time that the money remains invested drives the high yield return. In some embodiments, investing up front and leaving money is preferred over incremental investment where a portion of the money does not take advantage of the long-term of an investment. For example, a user may create a fund (such as a pension fund, investments fund, etc.) by investing one or a few small investments at the beginning of their career rather than small monthly and/or weekly amounts throughout the career. Optionally, the money, including interest, may be locked into an investment account over a long period of between 30 to 60 years and/or 60 to 100 years, or more for each investment cycle.

According to some embodiments, the doubling time for the investment may be dependent on the percentage return on investment, e.g., about 5%, about 6%, about 7%, about 10%, etc. Optionally, the doubling time may be reduced as the percentage return on investment is increased. Optionally, a specific number of doublings of the investment may be required before the accrued wealth may be accessed. Optionally, the number of doublings of the investment required to reach the same total may be reduced by increasing the amount of the initial investment, e.g., if the initial investor deposits an amount of $1,000 it would take 2 doublings to reach an amount of $4,000. However, if the initial investor could invest an amount of $4,000 as the initial investment.

According to some embodiments, the system may “lock” an investment. Optionally, the invested amount may be “locked” for a set period of time. Optionally, the system may permit withdrawal under specific pre-defined conditions. Optionally, the pre-defined conditions may be emergency circumstances, and/or extenuating circumstances. Optionally, the pre-defined conditions may be a pre-defined period of time, and/or pre-dined number of doublings, and/or pre-defined amount of money, and/or pre-defined value of the investment (e.g., a value equivalent to a pre-defined amount at a pre-defined date, such as $1,000,000 on May 31, 2125). Optionally, pre-defined conditions may include exceptions and/or early withdrawal of all or part of the funds due to a recipient, e.g., medical emergency, ongoing medical treatment, bankruptcy, war, terror attacks, purchasing a house, etc.

According to some embodiments, the system may prevent early withdrawal based on a contract. Optionally, escrow may prevent early withdrawal by the emissary, executor, trustee, etc. Optionally, the system may be managed by a third party. Optionally, the third party may be a emissary, and/or, executor, and/or trustee and/or steward and/or financial institution and/or artificial intelligence algorithm (AI). Optionally, the initial investor and/or a child once grown up may act as a legal guardian for the investment and/or the beneficiaries thereof. Optionally, the third party may act as a legal guardian for the investment and/or the beneficiaries thereof. Optionally, the third party may not be empowered to make decisions regarding the investment itself and/or the investment management, e.g., may not determine in which funds to invest and/or which stocks to buy, but may select the level of risk and/or investment company and/or investment policy and/or updated the investment company and/or investment policy as needed.

According to some embodiments, the third party may decide whether the pre-defined conditions for withdrawal have been met. Optionally, pre-defined conditions may include exceptions and/or early withdrawal of all or part of the funds due to a recipient, e.g., medical emergency, ongoing medical treatment, bankruptcy, war, terror attacks, purchasing a house, etc. Optionally, the pre-defined conditions for withdrawal may be configured to facilitate full and/or partial withdrawal. Optionally, the third party may include, for example, an emissary, an agent, a legal representative, trustee, steward and/or a custodian. Herein, unless otherwise specified, each of the above terms are used in a broad sense, include all of the possibilities.

According to some embodiments, the third party may consult with the user and/or a descendant thereof to define the amount to withdraw and/or to redefine conditions for future withdrawal. For example, an investment instrument may be based on a contract as follows: “As part of your investment fund to promote profits that may be deposited for family members through profitable investments and to nurture the investments by accumulating ten consecutive doublings of the savings amount, therefore I am entrusting you with this purpose today, the sum of $1,000. When my son reaches the age of 65 or before that under circumstances listed below, you may transfer the contents of the deposit to my son. Let him accept ownership of the fund and be free to do as he pleases with the money.”

According to some embodiments, a user may open an account for themselves, or a family member (e.g., partner, child, grandchild), friend, etc. Optionally, the account may function in a manner similar to a trust fund account. Optionally, a user may open an account for an individual for a pre-defined period e.g., a parent may create a retirement account for their child such as $1,000 invested for 65 years. For example, at 10% compounded yield an investment may double itself 10-fold over approximately 72 years (e.g., as explained below). Optionally, the user may open an account on the birth of the family member, as a gift, etc. Optionally, the system may permit withdrawal from such an account under specific pre-defined conditions. Optionally, the pre-defined conditions may be emergency circumstances, and/or extenuating circumstances. Optionally, the pre-defined conditions may be a pre-defined period of time, and/or pre-dined number of doublings, and/or pre-defined amount of money, and/or pre-defined value of the investment. Optionally, the system may prevent early withdrawal from such an account based on a contract. Optionally, escrow may prevent early withdrawal from such an account. Optionally, the fund may be managed by a third party. Optionally, the third party may be an emissary and/or executor and/or trustee and/or steward and/or financial institution and/or artificial intelligence algorithm (AI). Optionally, the third party may decide whether the pre-defined conditions for withdrawal have been met, e.g., emissary, trustee, courts, etc. Optionally, the government may encourage the use of such accounts e.g., by adding and/or matching the initial investment (thereby saving social security from bankruptcy).

According to some embodiments, the system may facilitate inheritance for future generations, e.g., children, grandchildren, great-grandchildren, etc. Optionally, a user may open an account for an individual for a pre-defined period e.g., a parent may create a retirement account for their child such as $1,000 invested for 65 years. Optionally, the user may open an account on the birth of the family member, as a gift, etc. Optionally, the system may permit withdrawal from such an account under specific pre-defined conditions. Optionally, the pre-defined conditions may be a pre-defined period of time, and/or pre-dined number of doublings, and/or pre-defined amount of money, and/or pre-defined value of the investment. Optionally, the pre-defined conditions may be emergency circumstances, and/or extenuating circumstances. Optionally, the system may prevent early withdrawal from such an account based on a contract. Optionally, escrow may prevent early withdrawal from such an account. Optionally, the account may be managed by a third party. Optionally, the third party may be an emissary and/or executor and/or trustee and/or steward and/or financial institution and/or artificial intelligence algorithm (AI). Optionally, the third party may decide whether the pre-defined conditions for withdrawal have been met.

According to some embodiments, the system may designate a third party as an intergenerational delegate (e.g., “emissary”). Optionally, the delegate may be a designated person, institution, or AI entity. Optionally, the delegate may be appointed to oversee the fund until the specified financial and/or temporal goals are met. Optionally, this role may include overseeing ongoing investment management, and/or ensuring compliance with the reinvestment and distribution principles of the system, and/or acting under a system mandate that is distinct from a standard power of attorney. Optionally, the system may include clear responsibilities, and/or a defined timeframe, and/or outcome-based targets.

According to some embodiments, the system may include a fee and/or oversight structure e.g., for the delegate. Optionally, the system may include a capped management fee and/or a progressive management fee. Optionally, the system may include oversight by a family governance body and/or trust. Optionally, the system may include the option to transfer fund management in the event of institutional failure and/or breach of trust, as predefined in the operational rules.

According to some embodiments, the system may include a non-transitory computer readable medium storing computer-executable instructions that, when executed by a processor, cause an artificial intelligence (AI) algorithm, such as machine learning (ML) engine to: train a machine learning model of the machine learning engine using financial datasets; providing parameter values to a Savings Plan Creator via a user interface; generating, by the Savings Plan Creator, a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan.

According to some embodiments, the savings plan is implemented by a financial manager module that creates a savings fund. Optionally, the savings plan includes a disbursement schedule which is based, at least in part, on milestones, the disbursement schedule being implemented by the financial manager module by disbursing funds to beneficiaries of the savings plan. Optionally, the milestones include a predetermined amount of relative wealth accrued; a birth or a death of a beneficiary; a predetermined number of times a value of the wealth accrued in the savings fund is doubled.

According to some embodiments, the AI algorithm is in communication with, and receives current financial data from, financial institutions, and wherein the AI algorithm is continually trained on the current financial data. According to some embodiments, the user interface is implemented on a website or application. Optionally, the savings fund is managed by the ML engine, wherein managing the savings fund includes making decisions including: where to invest, how much to invest, when to withdraw funds from investments, and combinations thereof. According to some embodiments, the disbursement schedule is managed by a virtual emissary and/or virtual trustee driven by the ML engine.

According to some embodiments, the milestones are met based on evidence submitted via the user interface to an Evidence Analysis Module configured to determine if the evidence is legitimate. Optionally, the Evidence Analysis Module is driven by the ML engine.

According to some embodiments, the long-term savings indicates that the savings fund may continue to generate wealth and effect disbursement of dividends after a biological death of an initiator of the savings plan.

According to some embodiments, the savings fund may generate wealth and effect disbursement of dividends at least during a lifetime of an initiator of the savings plan.

According to some embodiments, the system may allow each generation to withdraw a percentage of the investments. Optionally, the system may allow each generation to withdraw a certain percentage of the amount determined to be theirs by a previous beneficiary e.g., an emissary from the previous investment cycle. Optionally, the system may allow each generation to withdraw a percentage of the investments and reinvest and/or maintain a percentage of the investments for future generations, e.g., withdraw half and leave half for future generations. Optionally, the amount withdrawn may be divided between the existing descendants. In some embodiments, a fund may be opening for descendants, other people and/or organizations that have not been born and/or do not yet exist. Optionally, a trust fund may be opened for decedents. Optionally, each generation may have an input regarding the distribution of wealth of the descendants, and/or duration of the investment cycle, and/or pre-defined conditions, e.g., to take into account future financial conditions, tools, legislation, tax exemptions, etc. Optionally, the user may define a custom maturity date, overriding the default “generational cycle” and/or doubling milestone.

According to some embodiments, the system may facilitate generation of funds for future donations, e.g., in the name of the fund founder, family, etc. Optionally, the system may facilitate the creation of a charitable fund, scholarship program, building project, endowment, etc. For example, invest an initial amount of $1,000 for 100 years and have millions slated for donation.

According to some embodiments, the system may include an investment instrument and/or a savings plan intended for investment companies and/or insurance companies. Optionally, locking in the money in the system for a long period, e.g., up to 73 years. Optionally, the system may provide the user financial security during retirement, a nice inheritance gift, perhaps the most expensive gift given to their children. Optionally, the benefits to the beneficiary include a significant bonus beyond the pension money that the beneficiary has accumulated themselves. Optionally, the advantage for the investment companies and/or insurance companies is a minimal investment, negligible current expenditure, a guaranteed stream of commissions for the duration of the savings (e.g., more than 40 years) at an increasing rate. Optionally, the probability of receiving the predicted results may be good.

According to some embodiments, the system may include an investment plan intended for banks and/or other financial institutions and/or private investors. Optionally, the system may be a revolutionary investments plan based on the following: a) doubling index; b) disclosure of a new investment arena; c) a point of generating great wealth (e.g., as defined below with respect to the tenth doubling point). Optionally, the system may add doublings by advancing the investment. Optionally, the system may provide activation and/or integration of intergenerational investments. Optionally, a human emissary may be attached. Optionally, an artificial intelligence may serve as an emissary. Optionally, the system may facilitate taking advantage of long-term investments e.g., the increase continues according to the doubling index.

According to some embodiments, the system may be based on a single investment made by a user (e.g., at a child's birth), intended to grow (e.g., 1,000-fold) and may be accessed by the user and/or their descendants in the future, e.g., a gift for future generations. Optionally, the initial investment amount may be small, e.g., $10, $100, $1,000, $10,000, etc. Optionally, the initial investment may be made at any time, e.g., birth of a child, marriage, after a windfall, large payout, etc. Optionally, the system may permit withdrawal from such an account under specific pre-defined conditions. Optionally, the pre-defined conditions may be a pre-defined period of time, and/or pre-dined number of doublings, and/or pre-defined amount of money, and/or pre-defined value of the investment. Optionally, the pre-defined conditions may be emergency circumstances, and/or extenuating circumstances. Optionally, the system may use a doublings index method. Optionally, the financial metric system may be configured for comparing investment tracks based on the time required to double the original principal (a 100% return). Optionally, the index may provide a standardized way to compare different yields by calculating the time each rate of return takes to double the investment. Optionally, the model may be rooted in compound interest principles.

For example:
The first doubling increases the investment from 1 to 2,
The second from 2 to 4,
The third from 4 to 8, and so on.

After ten doublings, the investment grows from 1 to approximately 1,24-essentially a 1,000-fold increase.

According to some embodiments, the system may be based on a larger one-time deposit (e.g., made by parents at the beginning of their shared life (e.g., marriage)), creating a stronger capital base for future generations, e.g., a parental boost. Optionally, the initial investment amount may be small, e.g., $10, $100, $1,000, $10,000, etc. For example, deposits of no less than 100 for at least one year. Optionally, the initial investment may be made at any time, e.g., birth of a child, marriage, after a windfall, large payout, etc. Optionally, the system may permit withdrawal from such an account under specific pre-defined conditions. Optionally, the pre-defined conditions may be a pre-defined period of time, and/or pre-dined number of doublings, and/or pre-defined amount of money, and/or pre-defined value of the investment. Optionally, the pre-defined conditions may be emergency circumstances, and/or extenuating circumstances. Optionally, each generation may have an input regarding the distribution of wealth of the descendants, and/or duration of the investment cycle, and/or pre-defined conditions, e.g., to take into account future financial conditions, tools, legislation, tax exemptions, etc. Optionally, the user may define a custom maturity date, overriding the default “generational cycle” and/or doubling milestone.

According to some embodiments, the system may be for users without large savings, a long-term monthly investment plan that accumulates over decades to reach similar outcomes to a one-time deposit, e.g., monthly contribution track. Optionally, the initial investment may be a series of deposits, e.g., monthly deposits, quarterly deposits, etc. Optionally, the series of deposits may be discontinued after a pre-determined amount of time and/or when a pre-determined amount of money has been deposited. Optionally, the series of deposits may be discontinued by the user at any point in time. Optionally, the deposited funds may be “locked” until pre-determined conditions are met. Optionally, the system may permit withdrawal from such an account under specific pre-defined conditions. Optionally, the pre-defined conditions may be a pre-defined period of time, and/or pre-dined number of doublings, and/or pre-defined amount of money, and/or pre-defined value of the investment. Optionally, the pre-defined conditions may be emergency circumstances, and/or extenuating circumstances. Optionally, each generation may have an input regarding the distribution of wealth of the descendants, and/or duration of the investment cycle, and/or pre-defined conditions, e.g., to take into account future financial conditions, tools, legislation, tax exemptions, etc. Optionally, the user may define a custom maturity date, overriding the default “generational cycle” and/or doubling milestone.

According to some embodiments, the system may provide a surprise inheritance to a users' beneficiaries and/or descendants. Optionally, the system may be based on a single investment made by a user (e.g., $2,500 or $10,000, etc.) set aside for unknown future beneficiaries. Optionally, the gift may only be released once it has met certain pre-determined conditions e.g., multiplied 1,000-fold, etc. Optionally, the beneficiary may withdraw all the money or divide the money by deciding whom the next beneficiaries may be, e.g., the current beneficiary becomes the parent of the next generation. In the next generation, the authority passes on to one of the beneficiaries in the previous generation as the one who can decide what may happen in the generation of their children.

According to some embodiments, the system may provide a future financial boost for the users' descendants in their retirement years, based on long compounded family investments, e.g., retirement bonus gift.

According to some embodiments, the system may provide a pre-structured multi-generational plan. Optionally, each generation may receive part of the fund and reinvest the remainder for the next generation, forming a permanent wealth loop, e.g., Generation-to-Generation Gift. Optionally, the system may provide an intergenerational operating structure. Optionally, the system may facilitate growth of a one-time investment until pre-defined conditions are met, e.g., the 10th doubling, a predefined period (e.g., 72 years, etc.) or whichever comes first. Optionally, once the pre-defined conditions are met, part of the fund may be distributed among descendants. Optionally, each generation may select the amount to withdraw and/or reinvest. Optionally, each generation may designate their beneficiaries. Optionally, the inheritance may be divided among the beneficiaries. Optionally, each beneficiary may select the amount from their portion of the inheritance to withdraw and/or reinvest. Optionally, each beneficiary may choose to withdraw all or part of their share. Optionally, the remainder may be reinvested for another generation under the same framework. Optionally, this process may be repeated until the last beneficiary withdraws the full balance. Optionally, each generation may have input regarding investment opportunities, savings types, conditions for release of funds, cycle length, etc. Optionally, each generation may take into account current financial conditions and/or tools to update the system and/or maintain the wealth loop. Optionally, each generation may add a contribution to the saved amount. Optionally, each generation may have an input regarding the distribution of wealth of the descendants, and/or duration of the investment cycle, and/or pre-defined conditions, e.g., to take into account future financial conditions, tools, legislation, tax exemptions, etc. Optionally, the user may define a custom maturity date, overriding the default “generational cycle” and/or doubling milestone.

According to some embodiments, the system may provide an extended model which may lengthen the savings cycle beyond the average number of working years for a user, e.g., a period of 40 years beyond the average number of years of work of a user, e.g., 40 years to 80 years, or 120 years. Optionally, the system may maximize the power of compound growth for ultimate impact, e.g., Future Present Track. Optionally, the system may provide a generational investment system which may enable long-term financial growth and power transfer across generations through structured reinvestment and partial distribution every generation. Optionally, each generation may have the flexibility to define its own cycle length (e.g., recommended: 40 years), allowing for legal and structural protection against changing legislation, financial tools, location, etc. (e.g., 39-year variations). Optionally, each generation may have an input regarding the distribution of wealth of the descendants, and/or duration of the investment cycle, and/or pre-defined conditions, e.g., to take into account future financial conditions, tools, legislation, tax exemptions, etc. Optionally, the user may define a custom maturity date, overriding the default “generational cycle” and/or doubling milestone. Optionally, the initial investor may determine the length of the generational cycle.

Some embodiments may relate to a method which may enable long-term intergenerational wealth accumulation and/or distribution. Optionally, the method may include an initial deposit, e.g., a one-time deposit made by a parent, grandparent, or other entity in favor of a child or family member at birth or another milestone (e.g., marriage). Optionally, the method may include a growth phase. Optionally, in the growth phase, the investment may be held in a diversified, growth-oriented portfolio (e.g., index-tracking equity funds) and allowed to compound for decades, e.g., with the target of achieving a 1,000-fold increase over approximately 72 years (or 10 doublings), to obtain a yield of 10%, etc. Optionally, the method may include doublings index tracking. Optionally, the method may include doublings index tracking to track investment progress. Optionally, this index may define growth milestones. Optionally, the growth milestones may be defined by the number of times the capital has doubled. Optionally, the growth milestones may be defined by duration of investment. Optionally, the growth milestones may be defined by raw return percentages. Optionally, upon reaching a pre-defined milestone (e.g., 10 doublings, 72 years of investment, reaching a pre-dined amount, etc.).

According to some embodiments, a percentage of the funds may be distributed to eligible descendants of the original investor, e.g., 50% of the funds. Optionally, the remaining funds may continue to be invested for another generational cycle (e.g., typically 40 years). Optionally, during the next generational cycle a new list of beneficiaries may be defined by each recipient of the previous cycle. Optionally, a portion of the funds may be reinvested for the next generation. Optionally, a portion of the funds may be maintained in the original investment for the next generation. Optionally, in an intergenerational plan, the beneficiary of a current generation may determine the beneficiaries of the next generation. Optionally, if a beneficiary dies without leaving a will, the next generation may share in their portion.

Optionally, a third party may be entrusted to manage the fund according to predefined rules. Optionally, the third party may be an appointed family-appointed emissary, executor, trustee, institutional manager, management company that manages all the investments of all the different clients, or Al-based fiduciary. Optionally, the third party may ensure adherence to reinvestment, and/or eligibility, and/or payout criteria. Optionally, the method may include oversight and/or various fund protections. Optionally, a maximum management fee cap may be enforced (e.g., 0.1% annually). Optionally, a family supervisory body and/or trust may review performance and/or adherence to predefined rules. Optionally, the method may include one or more contingency plans to facilitate management replacement in case of risk, and/or breach of trust, and/or financial instability. Optionally, the method may include cycle continuation. Optionally, the process may be repeated by each generation, gradually building family capital over centuries. Optionally, the method may be flexible. Optionally, each cycle may allow full and/or partial withdrawal by each beneficiary. Optionally, each beneficiary may individually decide whether to continue the cycle or to terminate the line of inheritance. Optionally, this method may transform a modest initial investment into an enduring financial legacy.

### EXAMPLES

### Example 1

### First Step: The First Steps to Growth

The growth of money begins with a simple basic condition: an investment that drives the compound interest. Without an initial investment, growth may not occur. The initial investment creates the initial potential.

The engine that drives the process is compound interest. Compound interest is a combination of two factors: return and time. The speed of production is the return. The accumulation of profits and the rate of their creation is time.

The return defines the rate of growth. The rate of return may depend on multiple factors. Some factors may not be within an investor's control, e.g., interest rate, risk level in the economy, investment decisions, luck, etc. The only factor that is within an investor's control is time. It is time that allows compound interest to operate over a period of time and to have a cumulative effect.

### Step Two: A Unified Index

The following is a description of the inventors research to understand what happened in the past and to calculate it mathematically. In order to estimate, in advance, the potential of new investments at various risk levels to plan the desired return on investment.

There is a need to build a tool that to facilitate estimating the return in an intuitive, comparable and creative manner. Additionally, or alternatively, the same tool may be used as an aid in planning new investments for an investment fund.

To achieve this, the return may be transformed from a computational component to a result component. The index may combine the rate of return with the length of time of the investment. When the factors that combine the rate of growth—the return—with the length of time of the investment, it may be possible to predict future accelerations of investment at any time and at any return.

For all returns the question is: how long does it take for each return to achieve 100% profit?

Since a 100% profit is actually a doubling of the initial investment amount then when how many doublings occur in each investment period is known, the approximate investment results may be calculated. For example:

At a 10% return, it takes about 7.2 years to double the initial investment, so in about 14.4 years to double again.

At a 5% return (which is half the 10% return), it takes about 29 years for the initial investment to double twice.

### Step Three: Understanding how Wealth is Created Over Time

For example:

A father deposits an amount of $5,000 in an investment fund for a period of 40 years. The sum is invested at a return of 9%. The father recommends to his son that he does the same.

The son invests an amount of $25,000 for a period of 40 years.

In addition, the son invests an amount of $250 per month for 25 years—that is, a total of $75,000.

Both amounts are invested at a return of 10%.

After 40 years, the son checks on his investments:

The one-time investment of $25,000 has become $1,100,000.

The investment of monthly deposits, totaling $75,000, have become $330,000.

Total: $1,430,000

The son compares this with his father's investment of $5,000 invested at a 9% return for 40 years, and then continued for 40 years at a return of 10%.

He discovers that the additional 40 years at a return of 10%, has resulted in an amount of $7,100,000.

What happened in those extra 40 years that boosted profits by astronomical rates?

The surprised son learns that an initial investment of $5,000 can outperform an investment of $100,000, if the initial investment is invested for longer periods, e.g., an additional 40 years.

### Step Four: Discovery Stage

The incredible gap between $1.4 million and $7.1 million was clearly based was in the longer period of the investment, i.e., time.

What would happen if the investment continued for another period? Would there be additional doublings? How much is each doubling worth? And is it possible that most of the money wasn't created at the beginning of the process but rather in its continuation?

### Step Five: Long-Term View

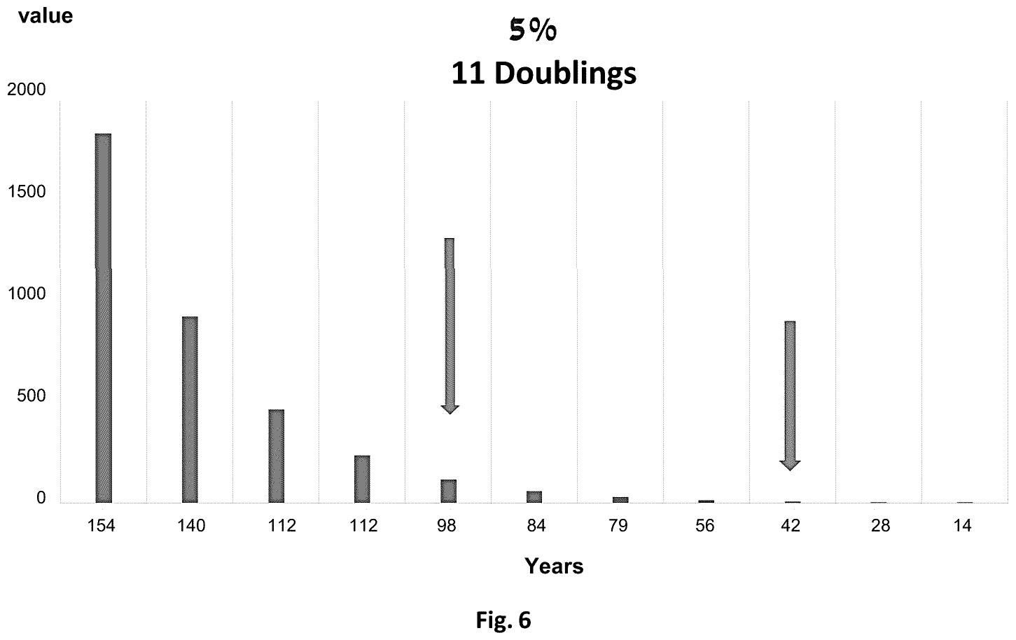

A visual sense of the principle is illustrated in the graphs shown in FIGS. 6, 7 and 8, which show the progress of an investment over 150 years, for three different returns: 5%, 7%, and 10%. In each graph, each cube represents a doubling stage according to the length of the period calculated for each given return e.g., 2×, 5×, 8×, and 10×. The distance between the cubes is determined by the number of years required to double the investments a given return (for example: 14 years at 5%, 10.3 years at 7%, and 7.2 years at 10%).

The graphs show that
The higher the return—the higher the number of doublings over the same period of time.
Each doubling increases not only the amount but also the gap between the graphs, e.g., each doubling adds an amount greater than the sum of all the amounts accumulated in the doublings preceding it.
The differences between the 3 graphs in FIGS. 6, 7 and 8 result from the large number of doublings for each yield over the same number of years.

For example:

At a 5% return, only 10.4 doublings can occur during this period, so the investment may multiply by 1,508 times

At a 7% return, more doublings can occur, 14.6 times, so the growth may be 25,560 times higher

At a 10% return, 20.8 doublings may occur, and the growth may increase much more, reaching an astronomical rate of 2,368,501 times.

It is worth noting the gap that opens up in the comparison between 5% and 10%,

10% is a doubling of 5 and the ratio of 2 is maintained but only between the number of doublings 20.8 versus 10.4.

But when it comes to the practical meaning between a number multiplied 10.4 times and a number multiplied 20.8 times, here the huge secret of the power of time that determines the number of doublings is revealed

10.4 doublings can only produce 1,508 times but 20.8 doublings already reveal the power of exponential leverage and increase the amount by 2,368,501.

It is worth noting that if one more doubling to 21.8 was added, the result would already be 2 times, that is, 2,368,501 multiplied by 2=4,737,002

The higher the return, the shorter the doubling time and the higher the number of doublings. This leads to exponential growth.

### Step Six: Two Investment Arenas

Observation reveals a surprising phenomenon in the trends shown in the graphs: At first, profits progress slowly-almost imperceptibly. Only after a long time do the profit curves begin to appear, and then suddenly a clear visual breakthrough is seen.

The first arena shows slow, limited growth and reflects what is familiar to most of us: a 40-year investment period, with a limited result by the average retirement age (64 years old). The length of this period also includes the period of years in which the stock exchange operates, that is, the successes of the investments even at a return of 10% for 40 years, which is considered so small that it does not even deserve to be expressed in any of the graphs examined over 150 years, that is, that further along the way, at every return, there is as if another arena where, with the same investment, with the same return, it is possible to earn sums that are hundreds and thousands larger than the achievements that can be produced in this arena.

The second arena, which begins after the first arena, presented a dramatic leap. Within it, each doubling adds more than its predecessor, and the sums rise to enormous levels: hundreds, thousands, hundreds of thousands, and even more.

The obvious question: Why stop at the first arena? Can the second arena be entered? Why not?

### Step Seven: The Gateway to Wealth

In all forms, the doubling method works in the same way. First, a profit of 100% is achieved. Then a profit of 200% is achieved, and so on. Therefore, the doubling index is suitable for comparison at all levels of return. The difference between them is only in the rate of progression of the doublings.

The higher the yield, the faster the doublings.

For all returns, the same process of accumulation takes place. It starts at zero and grows and accumulates profits and reaches a cumulative power of 100% at each return at its own pace. At this stage, the first doubling of the investment is recorded and each dollar becomes $2 and the process continues again, and the second doubling is reached and the $2 becomes $4. As the process continues, more and more doublings accumulate. In a period of time, the accumulation of the number of doublings is equal to the number of doublings at a return of 4%, whose profit production speed is low-few doublings may be created and as the scale of returns and/or the speed increases, the number of doublings may increase.

In reality of the common investment horizon of 40 years and within the framework of the representative return of the New York Stock Exchange indices in recent decades, it is not possible to make more than 6 doublings, i.e. success rates of up to 64 times. To improve the outcome, the 7th multiplication needs to be reached, which is always 2 times the multiplication that preceded it, and if successful, the investor may enjoy profits of 128 times.

The tenth multiplication is the basis for the 1000-fold plan.

Since the multiplication method is common to all yields and the change in the transition from the first multiplication to the second is worth examining how the transition to the higher doublings continues.

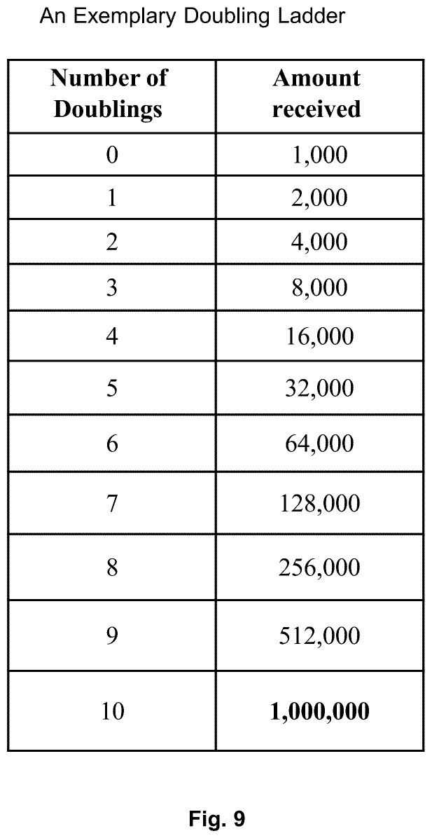

FIG. 9 illustrates the ascending column scale and the full range of meanings revealed. The doublings 1-2-3 are the beginning of the process and show how the profits develop to doublings 2-4-8. The numbers are multiplied, but the beginning is always from 1, and therefore the meaning of the profitability is low and amounts to profits up to 10 times.

The doublings 4-5 and 6—the profits are on the rise, but still represent modest profitability-profitability that amounts to a range of tens. This group of doublings represents the area of operation of the investment reality. Because within the framework of 40 years of savings in the range of returns of 4% to 10%, the entire range of results peak at 6 doublings with a return of 10%.

In the next group of doublings 7-8-9, an area of activity that generates profits in the hundreds in this series.

The main surprise is in the tenth multiple that increases the profitability by 1,000.

In the sixth multiple, the one familiar to most investors, 60 times was considered a great achievement, while here in the 10th multiple, only 4 above us the result is astronomical—it is already 1,000 times on an initial investment of $1 and the 10th multiple multiplies it by 1,000 times. That is, an investment of 1,000 may become in the 10th multiple an amount of 1,000,000 It is simply difficult to absorb and understand but the tenth multiple begins to produce wealth.

The 6th multiple takes 60% of the way to reach the 10th multiple but achieves a profit of only 0.6% of the profit created by the 10 doublings and the main profit in the method of doublings of 93.4% is created in 40%, which are the last stages of the structure, and most notable of all is the 10th multiple, which produces a profit of 50% of the total amount with 10% of the investment, and thus the system does not stop. Thus, the exponential development is created, which determines that compared to the 1,000th of the 10th multiple, the 20th multiple already produces a profit of 1,000,000 times.

The tenth multiple turns out that it proves that the same arena, the second arena, is not imaginary. It is completely realistic and is still in areas unknown to us. However, the disclosure of the 10th multiple clarifies 2 things: 1) that the tenth multiple is the gateway to the arena of wealth; and 2) the tenth multiple is and how to get to it, perhaps the way to reach it and utilize its power may be revealed.

The question before us is—is it even possible to reach the 10th multiple, and if so, how?

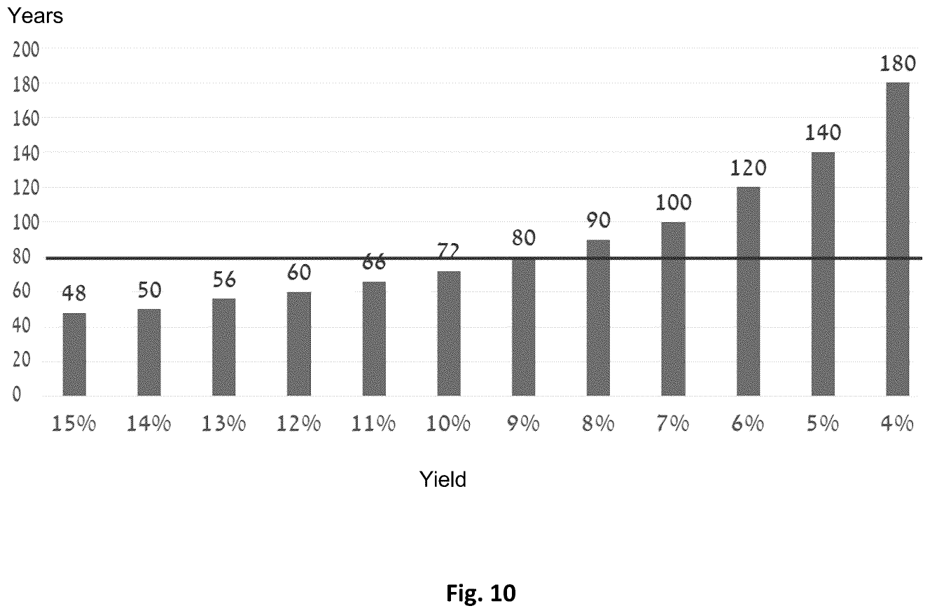

FIG. 10 illustrates the savings period beyond 80 years.

The figure illustrates the number of years required for all returns to reach the tenth doubling. The line through the 80th year distinguishes between returns that achieved prior to and after the 80th year e.g., those occurring in a users' lifetimes and those that are beyond the users' lifetimes.

First, the maximum possible area according to the life expectancy is 80 years. Is there any possibility that, given the returns familiar to most investors, a return whose time required to reach the 10th multiple may be within the time frame of 80 years?

This provides a small number of returns between 10% and 15%. A 15% return is ideal for only 55 years-longer than the usual 40 years but requiring only another 15 years of savings beyond the 40-year period, an effort that most people can withstand. The number of investors who may reach such a high return is quite small. 11% is within the realm of possibility, but 10% is already a common return that can already be built on.

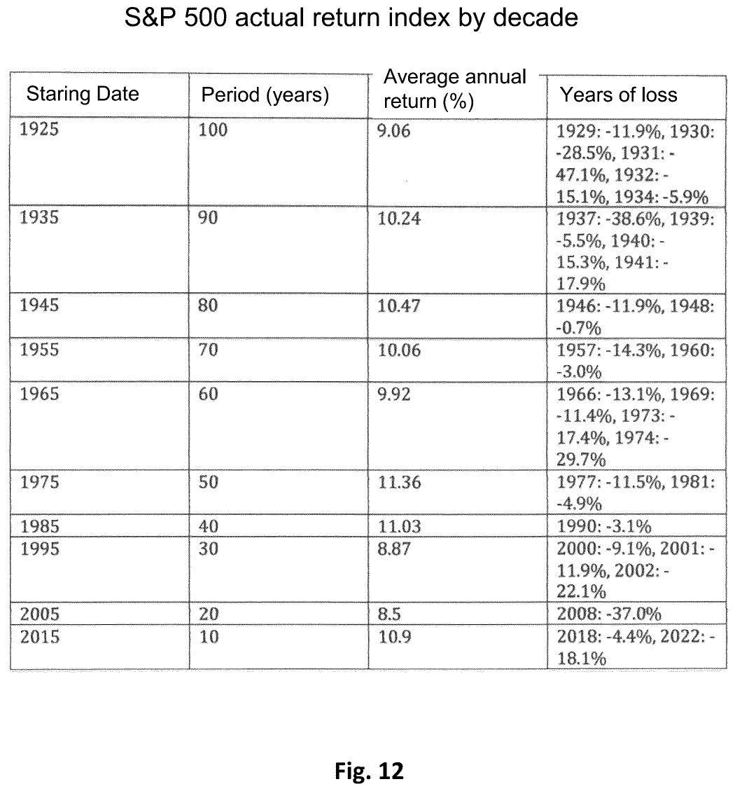

FIG. 12 illustrates the American economy as reflected in the performance of the stock market, allowed for growth at an average rate of about 10%. What may happen in the future, no one knows, but if there are no changes here or there and no drama greater than the dramas already experienced, for example, the 1929 crisis, two world wars and a multiple smaller wars, then perhaps it may be possible to a reasonable extent, assume that a 10% return is the best guess for what awaits in the years ahead. But, a 10% return still requires a savings period of 73 years

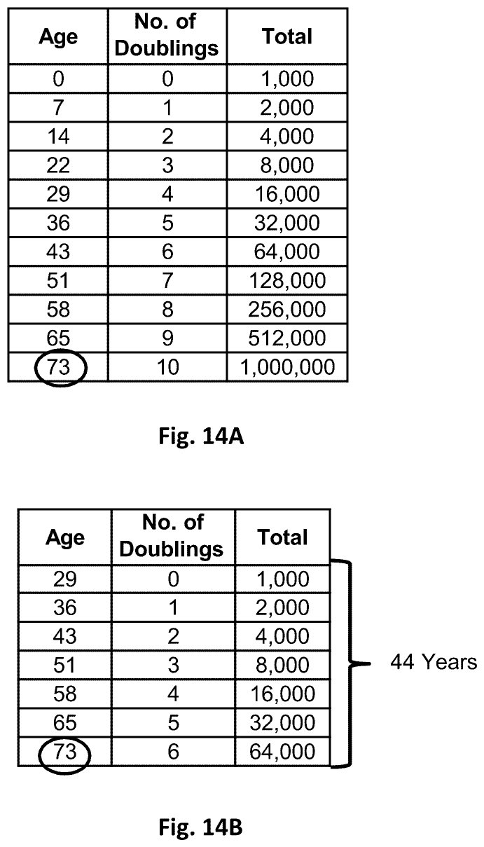

FIGS. 14A and 14B illustrate a comparison between a scale of 10 doublings. Routine savings begins at age 29 and ends at age 65 with a yield of 6 doublings.

Only an addition of 4 doublings is required to achieve 10 doublings, to extend the savings by about 28 years. That is, to finish the savings at age 93 years old, which is completely impossible. If you can't extend life and you can't add doublings, then how can the tenth multiple be reached?

While doublings cannot be added, they can be advanced.

The investment can be advanced. In the life of a young person, there is a period of their life unused for investment. A young man makes an investment after the age of 25 when he begins to generate income from which he sets aside for savings, and therefore the period until the age of 25, which is a 25 year investment period that can generate 4 doublings, can be advanced.

Therefore, the proposed solution is that when the young man is born, his father deposits savings in his name in the amount of $1,000. When the young man grows up, he continues the savings that have already accumulated 4 doublings and completes the full average savings period of 40 years, similar to the savings that he would deposit himself, and add his 6 regular doublings to the 4 that he received from his father. Together, the young man may benefit from the tenth doubling, which may create a gift for him from his father not of $1,000 but of $1,000,000 (assuming a 10% yield).

Although the full required savings period is 72.5 years and not 65, the date when he retires, but even if he needs liquidity due to circumstances already at the age of 65, Because of the size of the amount, he may only be able to realize part of the deposit, and the balance may continue to grow and multiply 1,000 times. In addition, the life expectancy of 80 years that awaits him and the fact that the return may be 1,000 times explains that this is actually a new type of investment that produces wealth for the beneficiary during their lifetime.

For example, a child may receive gifts from relatives for the same plan.

No one knows and certainly does not commit to what the returns may be in the future and they may be less, but if this service also applies to all the investments he makes.

Even with a 7% return, the amount he will receive will only be 128,000, but it is still very significant, considering the fact that it was created with an investment of only 1,000.

With reasonable probability a 10% return is a probability and since the importance of time for the investment exploits the power of compounding interest. The system allows anyone who is prepared to invest an amount that most of the population can afford to give the amount as a gift to their children in a new savings plan called 1,000 times and give them a chance to enjoy amounts that would definitely change their lives.

The 1,000 times savings plan is based on the following inventions:
The compounding method (“doubling method”)
The second arena
Tenth multiplication
Advancing doublings
Operation with artificial intelligence.

### Emissary—

The accounts that may be opened are for minors
1.—Banks and anyone authorized to manage savings plans, e.g., p1000
2.—Establishment or authorization or appointment of a legal entity to serve as an emissary
3.—Opening a dedicated trust fund to manage all savings funds
4.—Selection of a professional manager to manage the trust fund funds.
5.—Use of artificial intelligence

The parent or guardian signs an order to open a savings plan for the minor who may be the future beneficiary, deposits the money and appoints and authorizes an emissary as a guardian and responsible for managing the savings in his possession to prevent intervention by any external party and to carry out his mission to lead the investment or to the tenth multiple or when the beneficiary turns 65 years old, whichever comes first. The emissary may be authorized to release the funds in the event of emergency situations as detailed in the guidelines

The nature of the investment may be managed by the parent in consultation with the bank and taking into account the recommendations of the professional manager of the designated trust fund. When the minor reaches legal maturity, the responsibility for management may be transferred to them.

The parent or guardian or emissary or executor may be entitled to transfer, without prejudice to their rights, at any time the program funds in cash and securities to anybody authorized to manage the 1,000 times plan.

### The Method:

A parent applies to an institution that has a franchise to manage savings plans in the name of 1,000. The parent opens a savings account in the name of their child, as a future beneficiary, and invests money in the account, e.g., the minimum amount for the plan is 1,000. The parent can choose between a single investment in this amount or in monthly payments of at least $100 per month, specifying all kinds of optional conditions.

The savings may be invested in units in the trust fund, which is attached to the plan and managed by a professional manager selected by the institution. If the institution decides to simultaneously manage 2 trust funds with different investment characteristics, the parent may be entitled to choose to invest in one of them or divide the investment between the two at a time and in an amount as he decides.

When the future beneficiary reaches the age of legal maturity, the authority to manage may pass from the parent to the future beneficiary. Who may regularly receive all the banking information related to the plan that he is expected to receive when the emissary completes his mission. Optionally, he may pledge the plan funds for up to a period of 25 years, provided that the repayment date of the pledge coincides with the expected date for transferring the savings to his disposal

Since all forms operate according to the same mechanism of accumulation, there must be a common growth mechanism that is common to all forms. By arranging the doublings in an ascending order: the first doubling, the second, the third, and so on, it can be seen that the first three doublings, the doublings are 2×, 4×, and 8×, respectively, which are relatively marginal, suitable only for short-term and low yields. The next three doublings 16×, 32×, and 64× begin to show real results. This is the arena that most members of the public reach during an investment period, such as 40 years.

With the next three doublings a dramatic change is observed wherein the initial investment doubles 128×, 256× and 512×. The profits jump significantly.

With the tenth doubling, the profit jumps by 1,024×, entering the arena of wealth. This is the point at which the profits begin to be counted in the thousands, and therefore it is the gateway to the new economic world.

This doubling applies to every return. Each additional doubling creates a profit double the previous one and creates a profit greater than the profits accumulated up to that point since about 82% of the profit in any chain of doublings is created only in the last four doublings.

If it takes 42 years to reach 64× (a sixth power), how long may it take to reach 1,000×? This is the power of time.

### Step Eight: A 1,000-Fold Savings Plan

In the current reality, most people reach the 6^{th} doubling at retirement age. To reach the 10^{th} doubling and the gateway to wealth, an additional 4 doublings are required.

In terms of time, at a 10% return every 7 years there is a doubling, so an additional 28 years are required. That is, at age 65 an additional 28 years of savings is required, which is impossible.

A solution is to either invest a larger initial amount.

Additionally, or alternatively, while it is not possible to add years, but you can advance them. That is, to start investing earlier, e.g., to invest for a child. A parent can invest for a child upon their birth. Therefore, by age 28 years old, the child may already have 4 doublings on the initial investment. If the child continues to save, then in an additional 40 years a total of 10 doublings can be achieved, to reach a 1,000-fold return on investment by taking advantage of the child's early years.

The child does not need to invest additional funds. The parent gave the child the first four doublings on the initial investment, thereby giving the child his own time instead of his money, enabling the child to reach the gateway to wealth and the 1,000-fold return on investment.

The plan allows the choice of several additional investment tracks without changing the basic principles but including goals relating to the welfare of the future beneficiary.

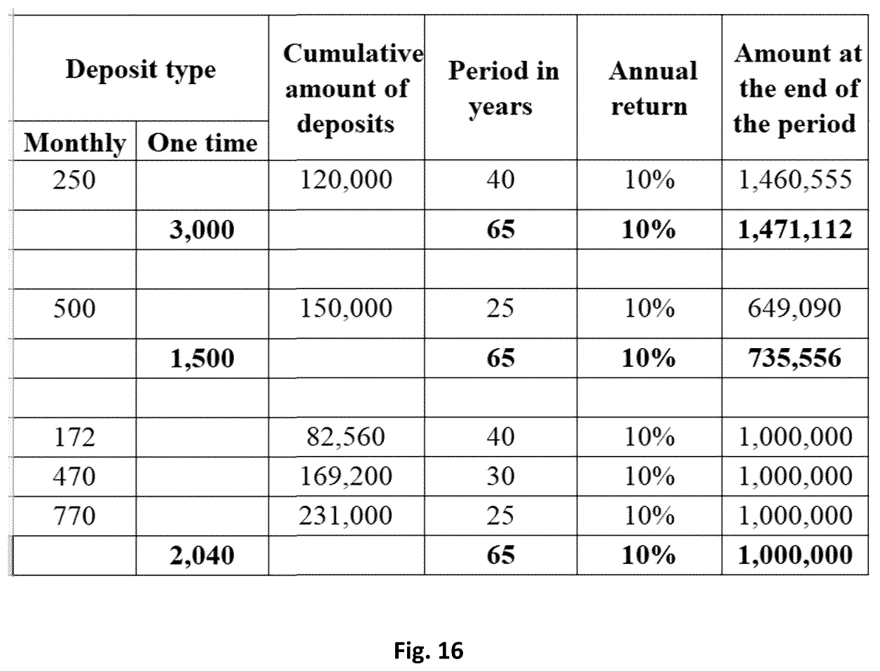

1. A deposit by the parent of $2,000 at birth for a period of 65 years may replace the need for the beneficiary to create a savings plan for himself by making monthly deposits over the 40 years of savings until retirement age (see for example, FIG. 16).

2. The “extended investment” track is intended for several related goals:

Depositing an amount of $6,000 which is intended for:

$2,000 for the beneficiary to acquire security regarding the collection of the gift amount

In the event of growth at a lower yield of 9%, the beneficiary may still receive $1,000,000 at 8%, the beneficiary may receive a sum of $500,000.

Three amounts of $1,000 to be transferred at the time of their birth for the benefit of each of their expected children and since the deposit may be made approximately 30 years prior to their birth, it may take another 42 years to complete.

An investment of 10 doublings assuming that the investment may yield a return of 10%, each may receive the $1,000,000 at a relatively young age when they may be able to take advantage of the gift to invest in a business, or in an apartment, or continue the savings in full or in part until retirement age and enjoy the doubling of the amount 30-40 times, a worthy addition in all opinions.

And the sixth additional amount of $1,000 may be offered to the beneficiary to transfer the savings to a continuation plan within the framework of the future present plan for the benefit of the next generation.

3. Track—“Surprise inheritance”

Deposit by the parent or grandparent at any time when desired, any amount over $1,000 with an instruction to the emissary, to complete a savings period as determined by the investor, and when the maturation date arrives, to divide the amount in equal parts between the investors' living descendants. To be a surprise inheritance gift.

4. Deposit in monthly deposits of at least $100 each month and for at least a period of one year.

5. A parent who did not have time to deposit at birth can also deposit up to the age of 7 in amounts that may be adjusted to the date between the amount of $1,000 and $2,000.

Parents whose children between the ages of 7 and 14 may deposit an amount between $2,000 and $4,000

Parents of children between the ages of 14 and 21 may be able to deposit amounts that may range between $4,000 and $8,000.

### Example 2

### Founding Principle

The next level in long-term family planning through exponential investment growth. The system may capitalize on reaching the 10th doubling (approximately a 1,000× increase), and may continue from that point toward the 20th doubling and beyond—targeting multi-generational wealth that compounds over up to 150 years and beyond.

### Program Objective

To transform a single generational gift into a multi-generational inheritance system by leveraging compound interest over very long periods, with each generation contributing to the next through pre-planned wealth transfer mechanisms.

### Basic Structure

1. A parent (e.g., a person who received a matured 1,000-fold Savings Plan) designates a portion, or all, of their final fund (e.g., $1 million) to an account-Future present.

2. This amount is invested for an additional 40 years, aiming to grow another 10× (or more, depending on the rate of return).

3. At the end of this period, the funds are distributed as gifts to the grandchildren (or great-grandchildren) of the original investor.

4. Each recipient is given the option to:
Withdraw their full portion.
Withdraw a portion (e.g., half of their portion), and re-invest the remainder for an additional 40-year cycle for their own children.

5. This process can continue indefinitely, as long as the investment yields a positive return, with each generation and/or each beneficiary individually deciding whether to continue the legacy or redeem the entire sum.

### Legal and Operational Highlights

Each generation passes the decision authority to the parent of the next generation.
The structure allows for full discretion: a parent may choose to divide, invest, or withhold the funds based on personal judgment and real-time circumstances.
If there is no designated parent to act as an emissary, a default form is used to register each descendant's individual claim.

### Economic Implications

Even if only one family and/or family member continues the cycle, the compounded effect is so powerful that a small initial deposit (e.g., $1,000) can result in cumulative real gifts amounting to hundreds of millions or more.
If each generation maintains even half of the received inherited capital for the next generation, and if the average real rate of return exceeds the average inflation by at least 5%, then the real value of the gift per descendant increases with each generation—even as the number of descendants grows.

### Philosophical Message

This is a form of economic “perpetual motion,” driven not by effort, but by time.
The vision is to allow time and structure—not capital or luck—to create intergenerational prosperity.
“If I managed to save even one descendant from financial distress, health crisis, or legal collapse-then all my effort was worth it.”

### The Family Gathering Vision

At the end of each 40-year cycle, the financial institution and/or managing institution and/or third party may invite all descendants to a central family celebration.
A pre-recorded video from the original founder and/or from parents, grandparents, even great-grandparents, etc. may be shown.
Each descendant receives a gift, e.g., flower bouquet, a greeting card, etc. and a check.
The event emphasizes heritage, unity, and responsibility—and hopefully makes clear that every beneficiary can become a founder.

### CONCLUSION

The system may allow small beginnings to lead to immense multi-generational results. It is an invitation to each generation not only to receive—but to pass it forward.

### Example 3—Future Present Savings Plan

The plan is based on the following inventions—
   The doubling index
   The second arena
   Doublings beyond 10
   Advancement of savings for longer periods.
   Transfer of savings from generation to generation.

A family foundation may distribute at least part of the profits from the foundation's fund as gifts to descendants. Each parent in a generation may share a portion of the profits from the foundation's fund as gifts to descendants. In each generation, the beneficiaries may be allowed to decide whether to withdraw the entire amount allocated to them or to withdraw only a portion, for example half, and to designate the other half the next generation. The balance may continue to generate new profits to distribute gifts to future generations as well. Optionally, a percentage (e.g., about 2%) may be deducted in order to cover inflation, and despite the increase in the number of offspring (calculated according to the rate of 3 children per parent), even an average annual return of about 8% may be sufficient to facilitate the distribution of profits.

With higher returns, the profits generated by the fund may be larger, and as time passes, these profits may continue to grow at an increasing (exponential) rate and the gifts distributed to descendants in future generations may grow and reach significant amounts.

The system may be based on the principal money being given as a gift to the family fund. The profits of the fund may be paid to the descendants of following generations (e.g., according to a power of attorney) by a third party, e.g., “virtual emissary”, etc. The “virtual emissary” may be an AI fund manager. Optionally, the third party may invest the money, and/or decide on a “disbursement schedule” to pay each beneficiary (or a group of beneficiaries) in subsequent generations. The payment may be a one-time sum and/or regular payments at intervals determined by the AI algorithm and/or a financial module.

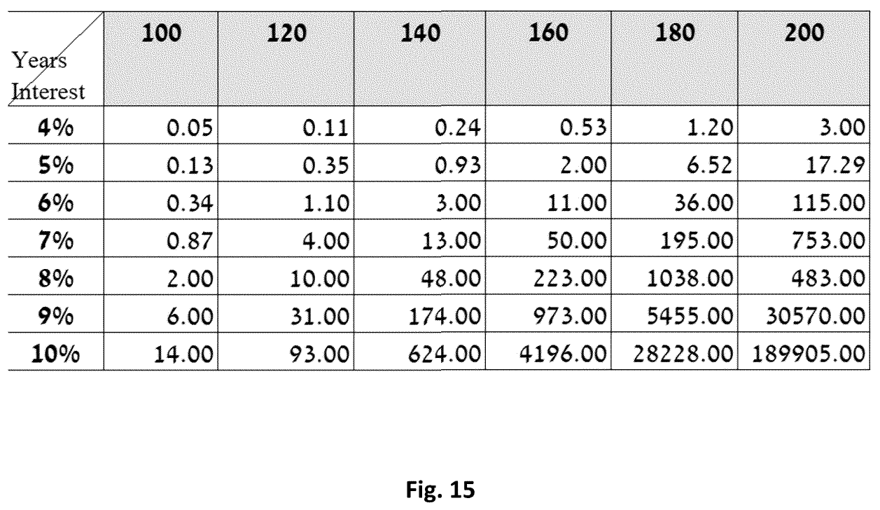

The system may facilitate the creation of a process that utilizes the power and strength of the “time lever” (i.e., time as a lever) to create future profits on a massive scale (e.g., FIGS. 15-17).

The program may be managed by a licensed trustee and/or an emissary who may be a regulatory approved body to manage a savings plan, e.g., a bank, insurance company, provident society, pension management companies, etc.

The program is based on long-term investments, which provide a decent return, whose funds may be invested in one or more designated trust funds that may be linked to the plan and managed by a professional unit, appointed by the trustee and/or emissary.

The plan is designed to utilize high doublings to accumulate adequate returns to finance gifts to descendants of each generation and transfer the balance of the fund to accumulate profits and distribute gifts to descendants of the next generation, and so on.

The program is based on the compound interest method. For example, the investment, with the help of a professional manager, aims to utilize the return on the stock market when most of the money may be invested in index-imitating funds as recommended today, and part as determined by the trustee and/or emissary in investments as chosen by the professionals managing the fund.

Since the plan is expected to be non-liquid at least for the first period and then for periods of 40 years in each generation, the designated fund may be able to determine the unit price only once new money that comes in may be at a uniform price that may be determined at once a month. Because of the locking of funds for long periods, the fund may be allowed to allocate part of its money (with regulatory approval) to invest in non-liquid assets, e.g., non-current assets, or in public tenders, or investments in start-ups, or private companies.

The plan may grant absolute power of attorney to parents in their generation. As long as there are funds left in the fund and the investment enjoys a positive return, the process can continue, theoretically indefinitely. The family plan may stop or lock when the last beneficiary withdraws the full amount from the plan.

The plan may be based on the idea of transferring savings from generation to generation. The transfer in the plan may be made every 40 years, and therefore the plan utilizes time, such that the investment accumulates additional doublings and increases the amount of savings at a proportional rate depending on the rate of return that may be achieved.

The plan is based on the assumption that as long as the economy grows in the decades ahead, may accumulate over the next 40 years, as it has over the past 150 years, as reflected in the New York Stock Exchange indices at an average rate of 9% to 10%, savings may accumulate an addition of between 5-6 doublings, meaning a doubling of savings on average every 50 years, which may increase the amount of savings between 30- and 60-fold.

Therefore, even if the amount the inflationary erosion of about 2% on average from a return of 10%, is deducted, and although only about half of the savings is transferred to the next generation, the half that may be available to the descendants of the next generation may still be higher than the amount that was available to the previous generation, and hence each generation may enjoy a gift at a higher rate than its predecessors received.

As the generations pass, and as long as the rate of return remains around the same level, the amount of the actual gift available to each descendant (assuming that each parent has 3 children) increases.

The plan takes into account the fact that no one may be able to predict in advance unexpected developments that justify changes in strategy in real time, so that in any situation there may be a factor that may receive in real time the authority to consider, consult with the emissary, (e.g., a professional investment manager and/or artificial intelligence) to decide and instruct the managing institution on the required change in order to adapt the investment situation to the predicted changes.

The parents of each generation and/or emissary may have the authority to make decisions regarding changes in the level of risk and the structure of the portfolio, as well as changing the size of the portion passed on to the next generation. For example, if there was a stock market crash in one generation and the expectation is for significant compensation in the next generation, the emissary could decide whether to withdraw their entitlement to all, as their ancestor determined, and prefer to leave the full entitlement to the beneficiaries as determined for distribution in the next generation. When the time comes for distribution, the beneficiaries' chances of enjoying gifts in amounts that compensate for their ancestor's distress may improve, and at the same time they may become those who decide in turn to protect the family savings funds in accordance with the advice they receive, just as their ancestors did for them. Another advantage of the decision is that it transfers authority to the parent in each generation, because who knows what is best for their family better than their parents.

As in every generation, each parent may be able to decide regarding their share, as determined before them, whether to take everything for themselves or to take only a part of the funds, and to decide how to distribute the remainder. The parent could decide between an equal distribution for everyone, a different distribution, who to favor, and even whom to disqualify, to decide on adding third party beneficiaries to the distribution of funds, etc.

The plan may be determined in advance by the initial investor, who may determine who in each generation has the authority to decide is automatically vested in the parent. Alternatively, the beneficiaries of each generation may receive half of their share and the remaining half may be kept for their descendants in the next generation.

Unless they decide to stop belonging to the family circle, then they may be paid the half intended for their descendants in the next generation. That is, to withdraw the full entitlement and thus his family may be disconnected from the partnership in the plan. Only when the last beneficiary withdraws their full entitlement may the plan be closed.

### Example 4—Wish Fulfilled

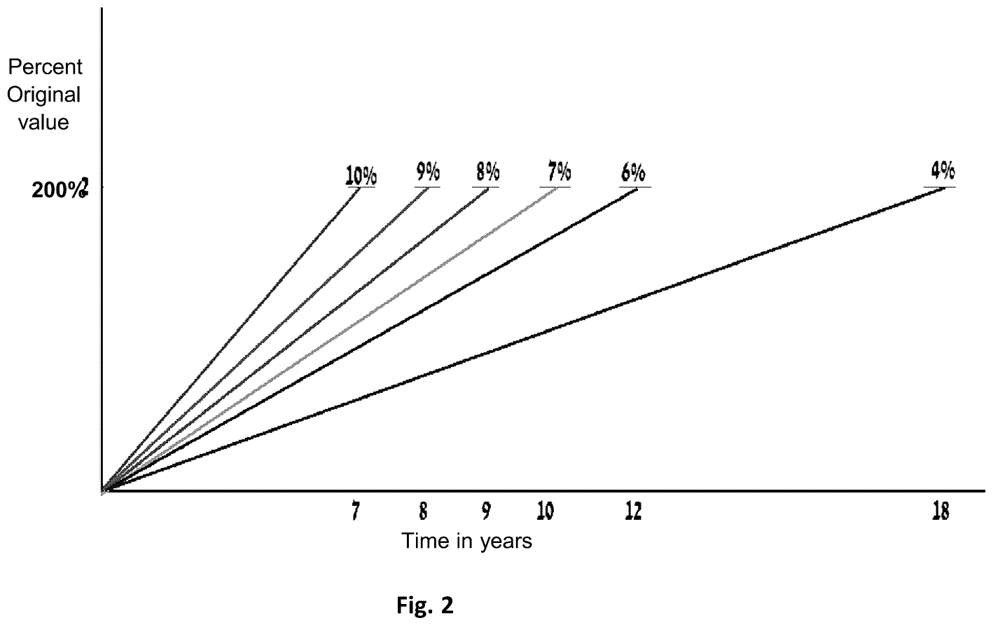

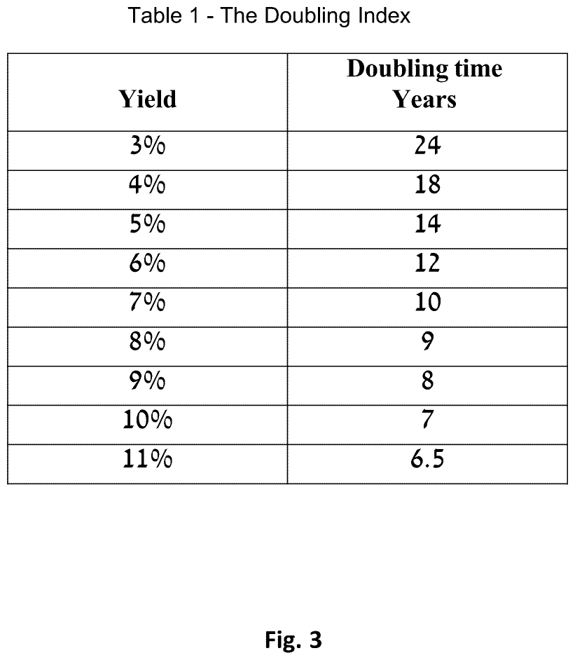

FIG. 2 and FIG. 3 are a chart and a table, respectively, illustrating amounts that are the result of an investment of $1,000 for periods of 100, 120, 140, 160, 180 and 200 years at returns ranging between 4% and 10%.

The idea is to allow any person who has had a wish or a desire to leave something in their name in memory e.g., as a testament to their status as someone who has done a significant philanthropic act in the field of kindness and charity, social, educational, social, national, or in any other field, to open a savings plan with clear instructions to the emissary on when, and/or where, and/or a specific and/or predetermined savings amount, to whom or for what the use of the savings funds is intended, for example, when 120 years of savings have been completed, to divide the proceeds between all the children born that year a particular date of birth, or between all the couples who get married that year on a specific date, or by commissioning a work of art or providing Torah scrolls for synagogues in a selected city, etc. Optionally, instead of choosing the length of the period, the investor may choose a designated amount e.g., no less than a specified amount, and if not by the end of the period suggested in the table, to donate the remainder of the amount in their name to a specified social body that supports the needy. The choices are many and any goal is feasible and legal would be welcomed.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. Reference is now made to the figures.

The invention is capable of other embodiments or of being practiced or carried out in various ways. The term interest rate and “annual yield” may be used interchangeably although there is a slight difference. A 10% annual yield is achieved by a daily compounded interest rate of about 9.5%. This difference affects the precise computations below, but not the conclusions and/or the embodiments of the invention work in the same way whether referring to interest at the instant interest rate or the annual rate.

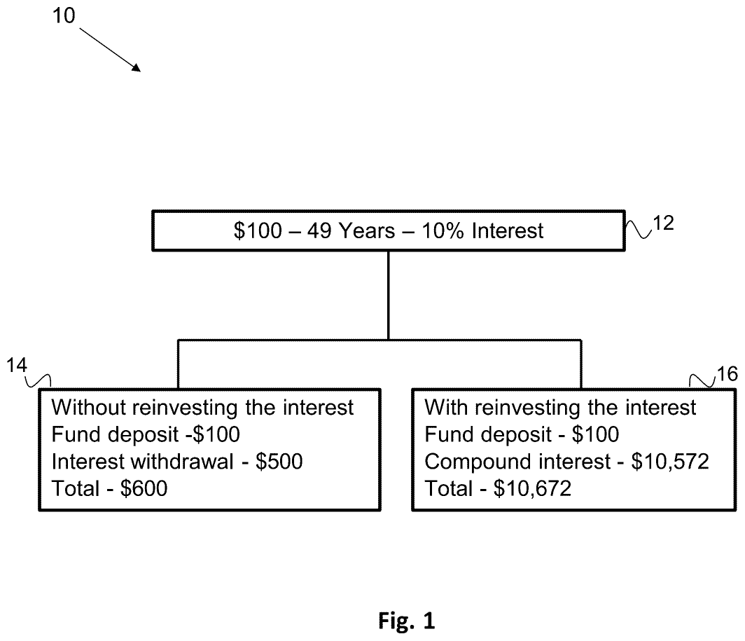

FIG. 1 illustrates the power of compound interest, in accordance with some embodiments. People often think of the rate of return as linearly increasing and do not realize the power of long-term compound interest. For example, in system 10, when an amount is invested 12 for a period of 50 years (e.g., $100 for a period of 9 years at 10% interest) and the interest accrued is periodically withdrawn 14, even though the total withdrawal is small, the total amount accumulated is far less than the total amount provided by compound interest invested 16 over a long term, even if the initial investment is the same. Even a small investment kept over a long time with compounded interest can make a large return on the initial investment.

FIG. 2 is a graph of long-term trajectories of investments against a logarithmic scale, in accordance with some embodiments; and FIG. 3 is a table illustrating the effect of different rates of interest, in accordance with some embodiments. In order to make it easier to intuitively conceptualize the effect of compounding interest and the relation of the interest rate to the yield of the investment comparison between FIG. 2 shows the number of years required for each investment to provide a 100% return on the initial amount of the investment. FIG. 3 is a table showing a breakdown of returns, with the number of years required to double the investment indicated for each return.

The difference between the interest rates is in the speed at which each rate produces the profit. To illustrate this, the concept of “the doubling index” is introduced.

As a basis for determining the index, the number of years required for each interest rate to generate a cumulative profit of 100% may be calculated. The meaning of 100% profit means, at that stage, the doubling of the investment.

For example, for an interest rate of 10%, the doubling index is 7 years, therefore the profit that may accrue on the investment of $1, at the end of every 7 years, is 100%, which is an addition of 1 more to the original investment and the $1 becomes to $2, and if this is continued and add 7 more years to the investment (together 14 years) 100% may be added to it again, but this time, the fund is already 2 years old and the addition this time is already $2 and the investment grows to $4, and another extension again of 7 years to 21 years of savings may create a third time doubling and this time from $4 to $8.

As can be observed, the increase in each doubling term of doublings is exponential, meaning that as the investment period is extended, more doublings are created, and the profit amounts that may be added in each doubling may increase. Additionally, the results of investments for any future term may be evaluated.

If the results of an investment of 7% for 40 years are evaluated, and since the 7% doubling index that the index is known to be every 10 years, therefore in 40 years there are 4 periods of 10 years that is 4 doublings and from this an investment of 1 doubling can be calculated, first to 2 followed by a second doubling to 4 and in the third a doubling to 8 and in the fourth the 8 is multiplied to 16. Therefore, any amount invested with a 7% interest rate may grow 16 times in 40 years (for the purpose of comparison, the calculated result is 14.97). With an interest rate of 8%, the doubling index is 9 (years), so in 46 years of investment there may be 5 doublings+one year's interest.

Therefore, it can be estimate that: first doubling from $1 to $2, the second to $4, the third to $8, the fourth to $16 and the fifth to $32. Adding another profit for one year, i.e. 8% on $32 and an estimated amount of 2.56 is obtained. The calculated result is 34.56.

The user usually starts saving as much as possible when they start generating income, that is, around the age of 25, and can set aside his income for savings until the age of 65, when they stop generating income and retire. That is, a savings period of over 40 years.

Herein the calculations are based on the users' initial investment, but the same investment strategy may also apply to gifts or funds received from a third party. Most investments are made in the capital market, and the savings amount and the length of the savings period differ from person to person. The nature of the investment and the risk are also different, so the degree of success is different from investment to investment and from investor to investor.

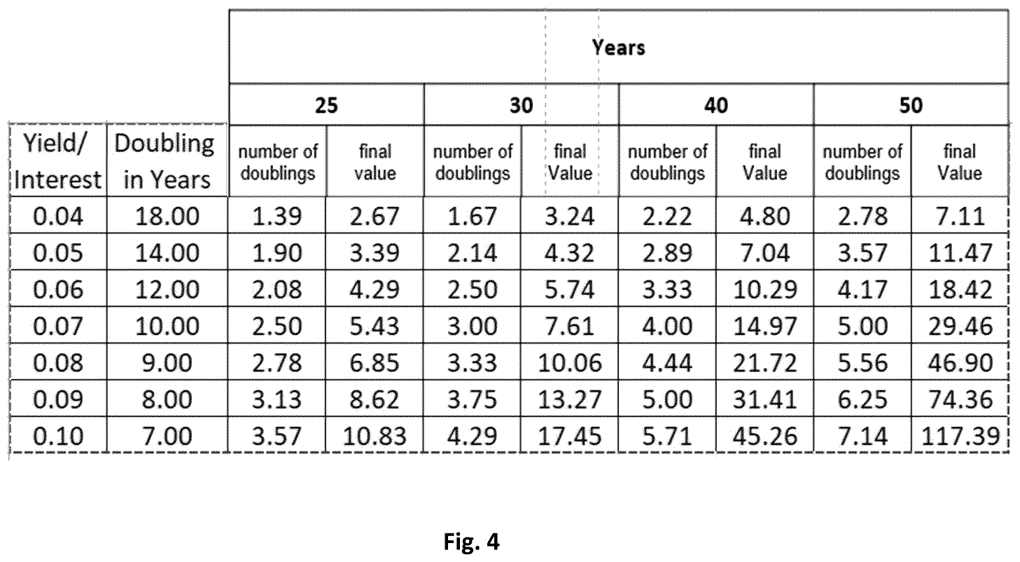

FIG. 4 illustrates a variety of investment results calculated according to interest rates between 4% and 10% according to investment terms of 25 years, 30 years and 40 years and 50 years, with each result indicated in a separate column. The number of doublings which were calculated according to the interest rate and the length of the period. There is a close relationship between the yield and the number of multiplications in a given time. The higher the yield, the more doublings made and ultimately the number of doublings determines the result.

The longer the savings period, the more doublings may be added, and the result may increase, and at the same time, as the interest rate increases, for the same reason, in that period, the yield may also increase. The degree of success is therefore according to time and yield. In the test between time and yield, when time is lacking, yield will not be able to take its place and fill the deficiency, whereas when yield is lacking, time can always take its place and complete the task. Therefore, the importance and power of time is greater.

A review of the results shows that those who invested for the shortest period of 25 years earned between 2.67 times on a 4% yield and 10.83 times on a 10% yield. And for those who utilized the full period of 40 years, with an interest rate of 4%, they achieved the result of 4.8 times, and by utilizing the best interest rate, that is, at 10%, they came out with the best yield in the table of 45.26 times the amount they invested.

In the doublings test, peak was at the 5.71 multiple, which means between 5 and 6 doublings. Estimated according to the number of doublings, the result may be between 32 and 64 times. Therefore, an investment of $10,000 at 10% reached 40 years later a cumulative savings of $452,600. That is, a profit of 45.26 times

If the investment time was extended from 40 to 50 years a cumulative savings of $1,173,900 is received, which means an addition of $721,300, this means that an addition of 10 years added more than the total of all the accumulation made in 40 years, while the previous addition—for 10 years between the 30th and 40th year. amounted to only $278,100. The huge difference is not due to adding money to the investment or an increase in the yield but rather due to extending the savings period by 10 years. But not every 10 years adds the same profit. The profit in the 10 years between 40 and 50 years was 4.22 times greater than the profit in the 10 years between 30 and 40.

The cumulative time, during the savings, has a decisive effect wherein a similar period later in the investment makes much more money than a period of the same length early in the investment. The further the measurement period is from the beginning of the date, the stronger it gets.

The table shows the dramatic difference that a change in interest rate makes in the time necessary to achieve a given yield. The table shows the potential to achieve dramatic yields with attenable interest rates over large time frames. For example, with an interest rate of 4 or 5%, in the adult lifetime of a person (approximately 50 years), one cannot only achieve modest yields of less than 10 times the principle. On the other hand, with interest rates of 7-9% one can achieve a few 10's of times his original money and with interest rate of 10% one can receive more than 100 times his original money. The table demonstrates the profitability of an investment over several periods of time, and considering different return rates (e.g., between 4%-10%) for an initial investment of $1.

For a deeper understanding of the process, an index has been added, termed the “doubling coefficient” (or simply “doubling”). Doubling the fund may double the result. But how may an additional 2% interest rate affect the result? Other than the simple understanding that 10% is more than 8%, and therefore a higher return may make for a higher yield.

How can a parameter with which to measure the success of each return rate be found? Success is determined by the speed with which money grows. The faster the growth rate, the less time it would take to double the investment. In FIG. 4, there is an additional column that specifies the stable doubling coefficient for each return rate; and in each investment period the number of doublings that each yield and/or return rate can produce.

The shaded cells (right column of each time period) depict the number of times the fund doubles in worth over the specified period.

The benefit of this information is the ability to see that these doublings create a geometric series. For example: With a 4% return rate and/or yield, the stable doubling coefficient has been calculated by the inventor as 18 years. Meaning, it takes 18 years to double the fund. With an 8% return rate, the stable doubling coefficient calculated is 9 years.

Over a 54-year investment period the investment is doubled 3 times with a 4% return rate (3=54:18). Therefore, the first dollar doubled to $2. In the second doubling the $2 became $4, and in the third doubling the $4 grew to $8. Meaning that an investment for 54 years with a 4% return rate-grows eightfold.

With an 8% return rate the doubling coefficient is 9 years (double that of the 4% return rate), and hence over 54 years there may be 6 doublings. The meaning of six doublings is 2, 4, 8, 16, 32, and 64. Meaning an investment for 54 years with an 8% return rate-grows sixty-four times. An 8% return rate is only double the 4% return rate; however, the success of the investment is 64 times, as opposed to only 8 times created at the 4% yield.

In the present economic reality, the period of investing funds is between the time one starts to generate income (which partly goes to savings), and the time when one begins to consume those savings. It is safe to assume that the duration of a standard savings period is 25-50 years.

In the present day and age, over a 50-year savings period, and given a generous 10% return rate-one could get to the best result of about 117 times the initial investment. A very decent outcome, however rare it may be.

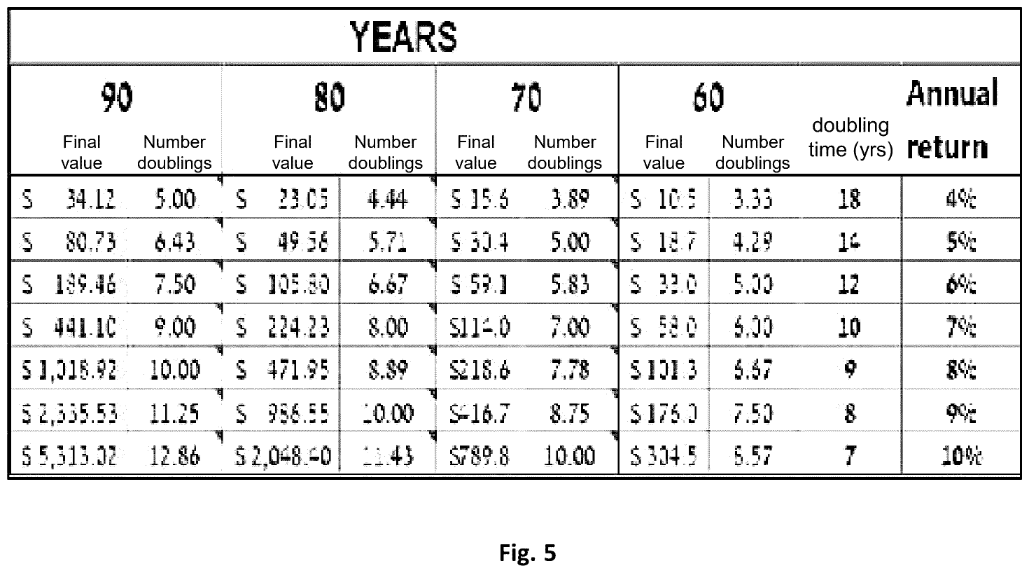

FIG. 5 illustrates the growth over a 90-year investment period at 10-year intervals, in accordance with some embodiments. A more common savings period would be 40 years. For the same 10% return rate the fund would increase 45 times the initial investment. This result is surprising. Shortening the investment period from 50 to 40 years reduces the profits from 117-fold to 45-fold? This roused the inventor's curiosity, and the phenomenon was given further consideration.

To better understand this extension, FIG. 5 shows longer investment periods, at 10-year intervals. The shaded cells (right column of each time period) depict the number of times the fund doubles in worth over the specified period.

Each 10-year extension to the investment period increases the fund in increasingly larger scales. For example: Given an 8% return rate, over 60 years-101.26 times, over 70 years-218.61 times, over 80 years-471.95 times, and over 90 years-1018.92 times.

The following example shows the data as viewed from another point of view. Example: My father invested in a fund for 40 years, with an 8% return rate. He was satisfied with his success-a growth of 21.72 times his initial investment. Meaning, if he invested $10,000-his savings account reached a $217,200 fund after 40 years. If I had the same success as him, I would also reach the same amount-$217,200.

For example, assume that my son, too, had the same investment with the same success. Now, picture an imaginary scenario—what would happen if my father decided to pass on to me his investment fund, when I began to invest myself? I would continue his investment, alongside my own, for an additional 40 years, at the end of which I passed my $217,200 to my own son.

Now, what if I opened my father's investment that was given to me, and that was allowed to grow for 80 years—what would I find? Well, instead of the $217,200 that I would find in my own fund (which I in fact passed onto my son) I would find my father's fund grew to a staggering sum of $4,719,500. The yield did not increase, the rate of return did not increase and no additional investment was made.

FIGS. 6, 7, and 8 depict graphs which describe the development of savings value over a 150-year savings period, given various interest rates of 5%, 7%, and 10%. After understanding the additional benefit of using the doubling coefficient in the test, the graphs were developed showing the calculated value of the savings, not according to a casual division of every 5 or 10 years, but rather in a spread according to the length of the period of the doubling coefficient for the same yield.

The figures illustrate that the power of compounded interest is greater over longer times of the investment, e.g., 150 years. The effect of time measured in intervals of the number of years of the doubling index adjusted for each yield. So that each column in each graph may be double the height of the column that preceded it and may be half the height of the column that may follow it. A phenomenon is highlighted that at a certain point the rate of increase in results jumps significantly. At the initial stage the trend line is quite flat and at a certain point a jump begins that goes up and up in increasing dimensions.

Two areas of activity are revealed:

A first arena, of the small numbers (ripening period) and a second arena of the large numbers (productivity period). The activity area of 40 years of savings is marked with an arrow. The best plausible result achieved in 40 years is 45.26 times the investment, which means a little less than 6 times. This is in the arena of small numbers when later on the number of doublings increases and the numbers increase at incredible rates.

The columns showing, on the X-axis, the size of the savings, are laid out in intervals according to the size of the doubling coefficient. So that each column may display double the height of the previous column. The picture that emerges from these graphs validates the information and meaning of extending the savings period. It also proves and reveals another fact. Looking at the shape of the curve of the graph, it seems that compared to an almost flat line at the beginning of the process, the curve line breaks and rises very sharply at some point.

This break is seen in the same place in all three graphs.

The explanation for this phenomenon is in the fact that although the amount is only doubled each time, the amount being doubled keeps increasing. At the beginning of the process and up to the tenth doubling, the increase is from 1 in the first doubling to 500 in the tenth doubling, (every 10 doublings increase the savings amount by 1000 times). From the 11th doubling to the 20th doubling, the savings increase from an increment of 1,000 to an increment of 500,000. The increments in the second period (11th to 20th doublings) is so significant and noticeable, it dwarfs the previous increments, making them appear as an almost flat line in comparison.

It can be seen in the graphs that the first 10 doublings, with their low profit rates, are nothing more than the ripening period after which one can begin to see the desired profit rates. An area where instead of the familiar growth of 50 times the dollar invested, one can see a growth of thousands of times, and up to 500,000-fold at the 20th doubling.

This leads to two conclusions:

First, there are no shortcuts. To get to the producing area, you must first go through all the stages of the process. One cannot get to the 11th doubling without going through all previous doublings, starting with the first. This means that in the best yield, 10% return, the doubling coefficient is 7 years, meaning one would need to save for 70 years before getting to the desired area of growth. With a more moderate return rate of 7%, with a doubling coefficient of 10 years, it would take 100 years to get to the producing stage of the 11th doubling.

Secondly, the length of the period. No person could live that long, and certainly not enjoy the earnings that such a plan could create. Apart from the time needed, there are no conditions or restrictions or additional requirements for entry. The process is simple: do not do anything, just let the fund grow without disturbing it, and the money may do all the work by itself.

However, there are two problems: (1) If the person who starts the fund cannot reap its benefits, who can? (2) Who could manage the fund, keep the principal safe and disburse the profits in a diligent manner, and make sure the process works over this long period?

A person may leave a large inheritance for their family with minimal effort and investment. An individual may invest a small amount, e.g., $1,000, and plan for it to grow significantly over a long period. Even though the original investor may not be alive to see the final result, they can pass the investment on to their family, such as their children, grandchildren, etc. The true gift isn't the initial small investment, but the large sum of money the family will eventually receive. The system may allow a parent to fulfill their dream of providing for their family with a very small initial investment and no ongoing effort, for as long as the family makes the decision continue with the plan, and an emissary can handle all the details for them.

FIGS. 4-8 show the development of an investment over 150 years at various rates of return. The graphs are constructed so that each return is examined and presented based on its multiplication coefficient. That is, the intervals that will display each calculation, on the x-axis, will be according to the number of years of multiplication for each return. Therefore, each rectangle that appears in the graph will represent the rate and progress of the multiplications and hence each rectangle will be double the height of the rectangle that preceded it and will be half the height of the rectangle that appears after them. The graphs show the development of the multiplications for each return. A curve represents a multiplication stage (2×, 4×, 8×, etc.), and the differences between them clearly demonstrate:
How a difference in yield creates a significant gap in the growth rate.
Each yield rate dictates the period of the doublings.
Each doubling doubles the amount of the number of doubling that preceded it.
The addition in each doubling is higher than the amount accumulated up to that stage.
The extension of the investment period dramatically magnifies the steps in the accumulated amount.
After 10 doublings the accumulated amount begins to increase dramatically.
The amount of time required to achieve 10 doublings at a yield of 10% is 72 years (the 72 yield index).

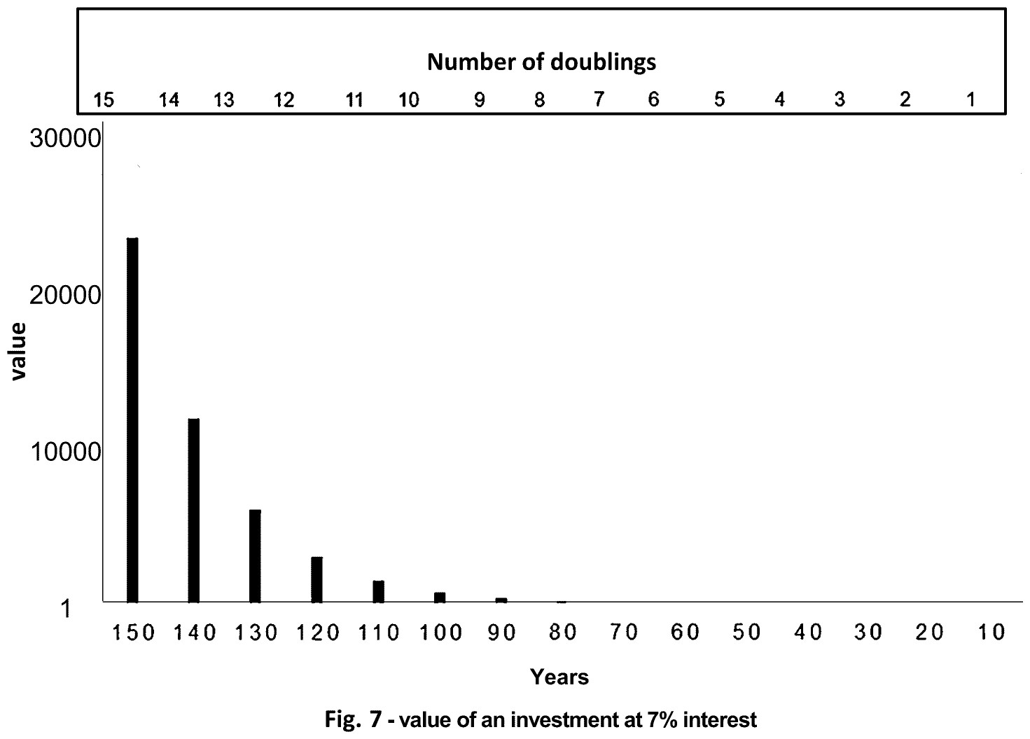

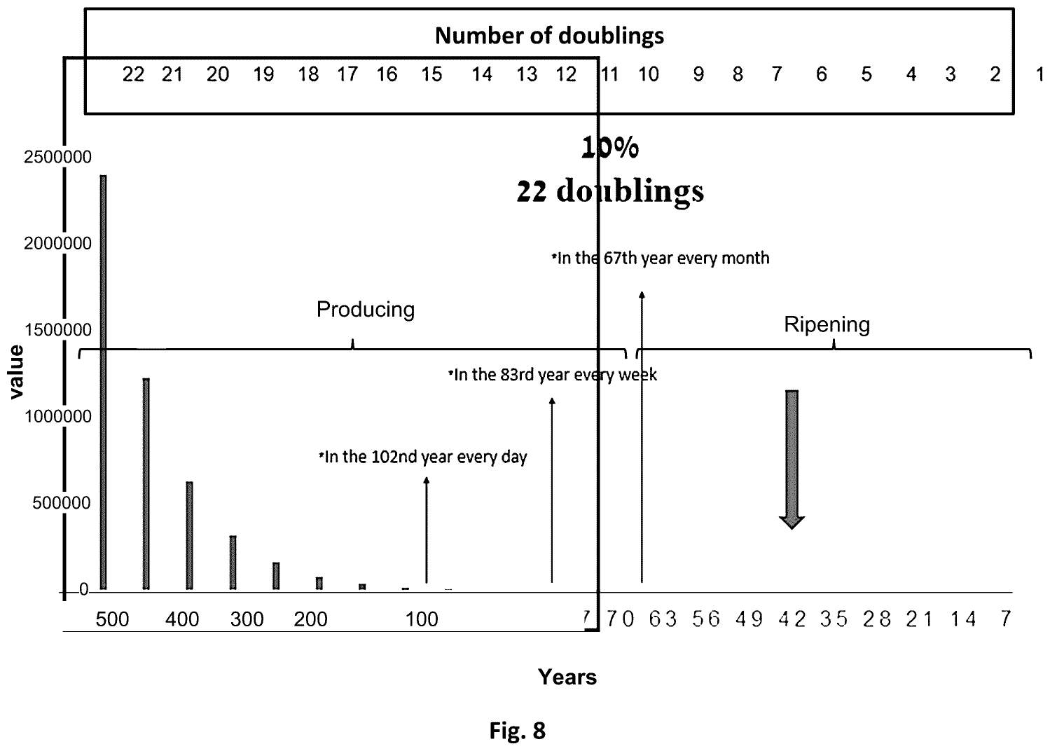

The doubling time of the investment provides a measure of the accrued compound interest. The number of doublings of the investment provides an indication of the effect of the accrued compound interest. For example, FIG. 6 illustrates that at a yield of 5%, FIG. 7 illustrates that at a yield of 7%, and FIG. 8 illustrates that at a yield of 10%. Massive growth occurs with compound interest over the long-term.

FIG. 9 is a table showing an exemplary doubling ladder, further emphasizing the power of doublings, as time passes, the amount of money grows exponentially, in accordance with some embodiments. The table is based on an investment of $1.

The first 3 doublings (e.g., 1 to 3) increase the investment amount up to 10 times.

The next 3 doublings (e.g., 3 to 6) increase the results by tens

The next 3 doublings (e.g., 7 to 9) increase the results by hundreds. The tenth factor multiplies the result 1,000 times

Compared to the sixth doubling which is the best achievement, the entry into the arena of great wealth starts from the tenth doubling. The time it may take to reach the tenth product depends on the speed with which each product is created.

As the graphs show, compared to the position in the graph around the 40th year, the arena of wealth is decades away. Particularly, it is seen that even a small investment of $1 doubling with compound interest can reach even a million dollars. For example, for a 10% interest rate, the doubling time is 7 years and an investor who locks his compounded interest of 10% can reach 10 doublings in approximately 72 years approximately $1,000. For example, an investment of $1,000 at 10% interest over 72 years may reach approximately $1,000,000. The main point is that as the time period becomes long, even a small investment may reach massive returns as long as the interest is kept and allowed to compound.

FIG. 10 is a graph illustrating what interest rate would be necessary to reach 10 doublings in a normal lifespan, in accordance with some embodiments. For example, in a lifetime of 80 years (the line), at an interest rate of 4%, the amount of time to reach the desired number of doublings would be far greater than the lifespan of a normal person. At an interest rate of 15% within a person's lifespan of about 50 years it is possible to achieve 10 doublings. The line marking 80 years is shown to check if there is an interest rate that may bring us to the tenth multiple close to or at least below average life expectancy line.

In terms of the implementation options for the general public, this option is not possible. The best average return for decades is around 10%, which requires an investment for 72 years. Withdrawing money at age 65 means that an additional doubling will be mussed, therefore the money available at age 65 would be half of the amount of money available at 72 years old. Realization of this plan could be postponed, allowing the plan to continue to accumulate profits, so that in practice, even if not everyone takes advantage of the plan's optimum, its significance may still be felt in the lives of most beneficiaries.

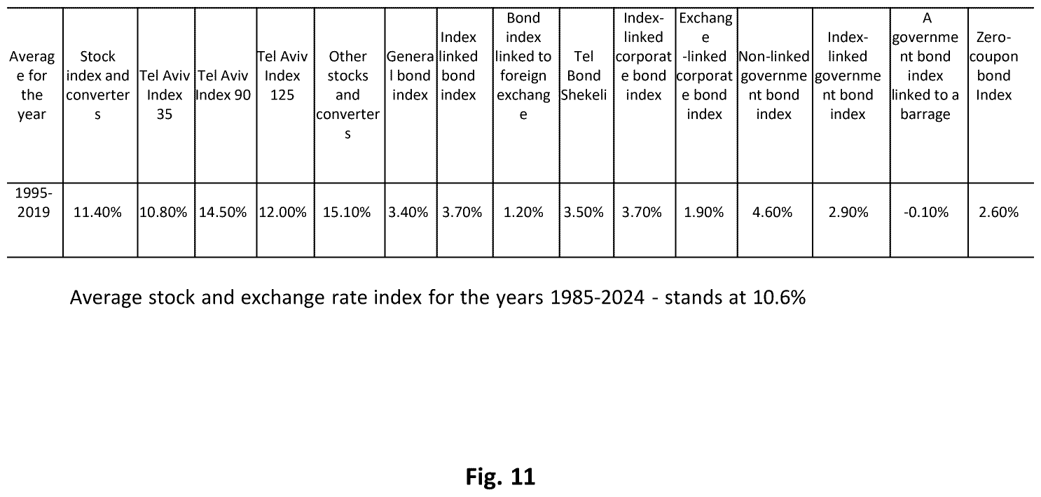

FIG. 11 is a table illustrating a reasonable expectation of interest rates based on data from 1985-2019, using various available financial instruments (e.g., the Dow-Jones, Tel Aviv stock exchange, etc.), in accordance with some embodiments. FIG. 12 is a table illustrating the S&P 500 index over various time periods. FIGS. 11 and 12 show that a 10% annual interest rate is possible over a long time. This makes it possible to reach 10 doublings in approximately 70 years.

It may be possible to rely on the strength of the economy, and on the constant growth thereof. Based on the New York Stock Exchange in the last 150 years and the Tel Aviv Stock Exchange in the last 40 years-one can assume with a reasonable level of certainty that the returns in the future may be similar, or close to, those returns. Even if the market grows at a lower rate—a correct use of the plan would still produce a satisfactory profit.

The Dow-Jones indices in two consecutive periods of 50 years and in a total cumulative period of 150 years and despite the severe crises that happened in each of the periods, (crisis of 1929 and world wars) still the indices were conducted until now and recorded interest rates between about 9-10% and similar interest rates were recorded. In the indices of the stock exchange in Tel Aviv for the last 40 years. Therefore, as long as the economy and the financial markets continue to behave in a similar manner, more or less in the future, then it is reasonable to expect that the market interest rates may also be around the same level between 9-10%.

Although there is no certainty that this may happen, but with the same degree of insecurity investments continue today. Therefore, there is at least a probability that if there is no deep crisis and with good management, it may be possible to achieve similar interest rates.

Assuming that a 10% interest rate in the coming years is not impossible and maybe even reasonable, adults may not be able to both invest and reach the tenth multiple after 72 years. Adults may not get to enjoy the huge profits that the savings may generate, but their children, whose possible life expectancy is more than 80 years, the young ones, especially newborns and in some cases even up to the age of 14, have good chances to take advantage of the tenth doubling and enjoy profits of 1,000 times the amount of the savings.

Some embodiments below include a savings plan tailored for this purpose.

The following exemplary embodiments of the current invention give exemplary methods and financial instruments that facilitate a person achieving a personally valuable goal with the massive potential of long-term compounded interest. The general idea is that a person can appoint an emissary and/or trustee (human, institutional and/or electronic) to invest a modest amount of money over a very long time, retain and compound the interest and make it available to a goal that is valuable to the original investor. For example, the goal may include the wellbeing of one's decedents and/or increasing the potential of one's decedents and/or an altruistic ideal and/or eternalizing one's name.

FIG. 12 is a table illustrating the S&P 500 actual return index by decade, in accordance with some embodiments. For example, while some time periods include years in which the S7P 500 index performed poorly, overall for each time period the index made a profit of between about 8.5% to about 11.5%, indicating that it is possible to predict a continued increase in overall yield.

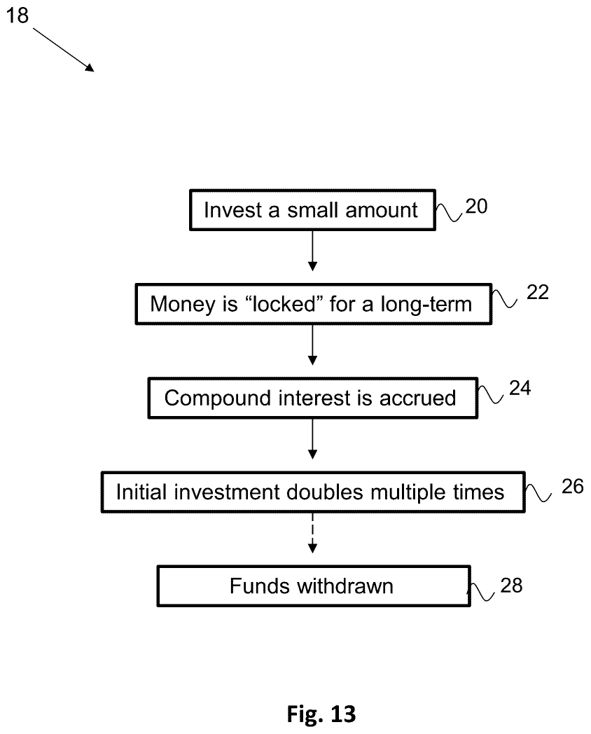

FIG. 13 is a flow chart of a method of use, in accordance with some embodiments of the invention. For example, in method 18, a user invests 20 a small amount of money as an initial investment, the money is “locked” 22 for a long-term period e.g., withdrawal is inhibited except under extenuating and/or emergency circumstances. Compound interest is accrued 24, such that the initial investment doubles 26 multiple times before the money, or part, may optionally be withdrawn 28.

FIGS. 14A and 14B are tables illustrating the advantage of the system, in accordance with some embodiments. For example, an investment at the birth of a child (see e.g., FIG. 14A) and/or at the beginning of a career (see e.g., FIG. 14B) locked up over a long term.

FIG. 15 is a table illustrating various investment plans by investing $1,000 for between 100-200 years at various interest rates to show the return provided by compound interest on the initial investment, in accordance with some embodiments. These figures might be relevant for an investment instrument opened for one's grandchildren and/or great grandchildren and/or further generations and/or for investors who have not been able to realize their dreams during their lifetimes, for example, of immortalizing their name, whether it is a ward named after them in a hospital, or donating Torah scrolls to synagogues. This can be in the social, social security direction, or for example, to distribute on the repayment date as they determine the conditions in advance, gifts to couples who may get married that year or to children from that year, or whatever comes to mind, provided that the instruction is applicable and legal. The emissary appointed on their behalf may take care of bringing the deposit on the date or in the amount as instructed and carrying out the mission they have set for him. FIG. 16 is a table illustrating the comparison between a conventional retirement plan verses a one-time investment, e.g., at birth, at the same interest rate, in accordance with some embodiments. For example, the table illustrates a comparison between a conventional retirement plan (a monthly deposit (e.g., of $172, $250, $470, $500, $770, etc.)) verses a one-time investment (e.g., of $1,500, $2,040, $3,000, etc.) at the same interest rate (e.g., 10% interest rate) illustrating that the same amount of return can be achieved investing much less money if a significant small investment is made early as opposed to investing slowly over time wherein a much larger amount must be invested to get a similar yield. Thus, for example, a person may achieve a big retirement account with a relatively small initial investment early in his life and locked for a long time of compounding returns rather than the current manner of collecting money throughout their working career.

For a conventional retirement plan to yield $1,460,555 by retirement at age 65 one would have to invest $250 monthly over 40 years of working. The total invested money would be $120,000. On the other hand, for example, a long-term investment (e.g., $3,000) put in by a parent for his child and locked up over the same 65 years would yield a similar return ($1,471,112) with a total investment of $3,000 ( 1/40 of the amount invested). For example, a parent could plan for their child's or grandchild's retirement and/or finance their purchase of a house, etc. This could be done with much less investment than conventional savings plans based on investing gradually over the period. The parent's advantage is in the length of time that an investment may last, which may reach 9 multiplications by the age of 65, while the monthly investments made by their child may on average reach a maximum of up to 20 years, and even if they are in significant amounts, they will still only reach the third doubling in the best case, and this is exactly the meaning and method of how to utilize the power of doubling.

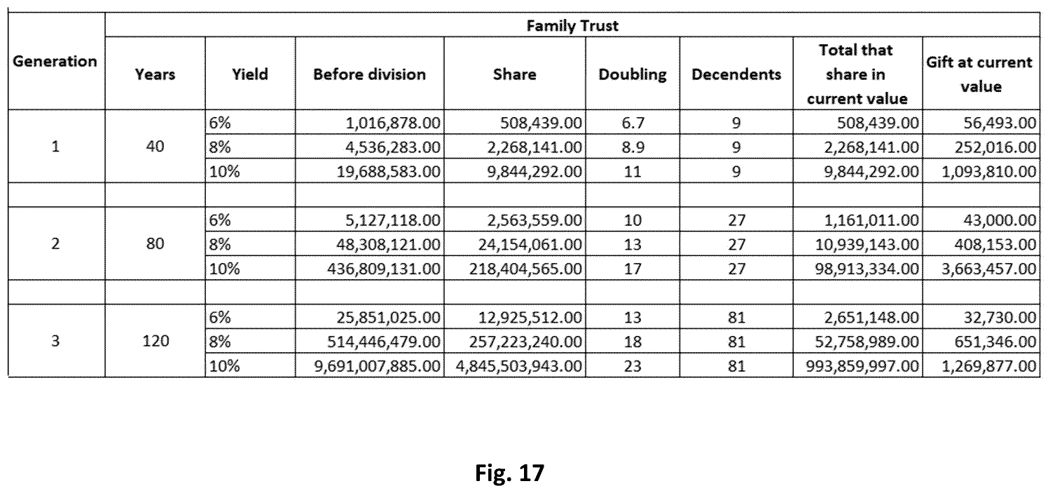

FIG. 17 is a table of a multi-generational investments plan based on an initial small investment, in accordance with some embodiments. The investment plan takes advantage of a novel concept of multi-generational investing to facilitate taking advantage of vastly increasing wealth after the 10th doubling. In this way, a vast quantity of money increases over time, faster than the number of descendants and from generation to generation (e.g., each generation may be 40 years), each decedent gets an ever-increasing gift. For example, a sum of money is put away in savings for a long-term investment. Each generation is permitted to withdraw a predetermined portion of the invested amount after a pre-determined period (e.g., half the amount in the fund every 40 years). The withdrawn portion may be divided among the surviving members of that generation (e.g., divided equally among siblings and/or cousins). The remaining portion is left in the investment fund for future generations (either mandatory and/or voluntary).

Savings plan.

A sum of money deposited in this plan is invested over the long term to accumulate a number of multiplications and create a significant amount of wealth that will serve as a platform for distributing gifts to the descendants of the family over generations.

The entrepreneur deposits in the name of his child at birth an amount of $1,000 in a 72-year plan that invests the money in investments such as index-mimicking mutual funds or similar ones in order to take advantage of the rise in the stock market with a wide spread that will reduce the level of risk. Assuming and hoping that the stock market indices will rise by 10%, as they have done over the past 150 years, the savings will double ten fold and the amount of savings will increase 1,000 times to a value of $1,000,000.

At this point, the owner of the savings agrees to his father's recommendation to designate the savings for his grandchildren and to that end, he will continue the savings for another 40 years. Assuming that the market yield continues to rise at a similar rate of 10%, the deposit amount will increase 45 times, i.e. to a value of $45,000,000.

At this point, the gift-distribution phase begins-assuming that the son has 3 children and each has three children of his own, he will have 9 grandchildren to distribute.

The grandfather offers each of the grandchildren to receive 1/9 of the savings, i.e. an amount of about $5,000,000, a reasonable amount by all accounts.

The grandfather even offers them all an additional suggestion, which is not binding, to settle for half of the gift amount and transfer the other half as continued savings to their children who will grow up after 40 more years of savings.

The grandchildren are allowed to withdraw the entire gift amount and the program will end, but assuming and for the sake of full disclosure of the program's potential, let's assume that everyone, as fathers to their children, agreed with the recommendation, each will receive an amount of $2,500,000 and the remainder of the deposit will continue the process to the next generation to be paid after 40 years.

The amount transferred was half of $45,000,000, i.e. $22,500,00 and the campaign moves on to the next generation.

Each of the grandchildren who started the plan will have 3 children and the savings of $22,500,000 that continued to accumulate profits will arrive after growing again 45 times, assuming that the return is still 10%. To the amount of $1,12,000,000.

The numbers presented are nominal, meaning erosion of the value of money as a result of inflation is ignored. To evaluate the growth process, inflation must be added to adjust the amounts to real values. “Historical U.S. inflation has averaged about 3.3% over the past 100 years, and approximately 3.5-3.8% over the last 50 years. However, in the most recent 25-year period, the average has been closer to 2.5% per year, reflecting a more stable monetary environment. Accordingly, when constructing long-term economic models, it may be more realistic to apply an inflation assumption in the range of 2-2.5%, rather than the higher long-term historical average.”

Based on the inflation forecast to be between 2% and 2.5% and to remain in the real range, the calculations may be updated and 2.25% subtracted from the yield. In real terms: instead of a 10% return, a real return of 7.75% is considered. The exact result for 40 years is a growth of 19.8 times instead of the nominal growth of 45 times. For simplicity and ease of calculation, round 19.8 times to 20. Therefore, assuming a return of 10%, an average inflation of 2.25%, and an initial investment of $5,000, the following results will be seen: At the end of the first 72 years, savings of $1,078,981 are received. Round the number to $1,000,000. Each generation is assumed to be 40 years. The growth in each generation is 19.8 times, for convenience and simplicity, this has been rounded to 20 times (the differences between the exact and the rounded are quite marginal and not will significantly distort the data presented).

A father suggests to the son to turn this savings into a gift for generations, the son agrees, the savings are extended by 40 years and the savings grow 20 times and reach a balance of $20,000,000, there are 9 grandchildren, each entitled to the amount of $1,111,111. Assuming that all 9 grandchildren are willing to settle for $10,000,000, in real values, the savings balance of $10,000,000 is extended again by 40 years, at the end of which it grows 20 times and the savings reach the amount of 200,000,000 and hence continuing the program of the one who again offers each beneficiary who are the children of the 9 grandchildren, each of whom has 3 children and the program already deals with 27 descendants.

Each descendant gets $7,407,407 in real terms and according to the plan, it is again proposed to settle for half of a proportional share in savings to receive an amount of $3,703,703 and the remaining savings after half of it was distributed to the children of the generation, there remains a balance of $100,000,000 that continues to the next generation—that is, to the children of this generation—in 40 years. And again the turn of the next generation comes and the amount of $100,000,000 has grown again 20 times and reached the amount of $2,000,000,000 and again in real terms and again the process repeats except that this time the number of descendants has grown 3 times and with 81 children of the previous generation.

Distribution of the balance of the 2 billion dollars is proposed to be divided between 81 descendants, and each person is again recommended to receive $24,691,358 or to settle for half the amount and transfer the second half of each share to the next generation.

For example, in a 3 generation process starting with a basic investment of $5,000.

The 9 grandchildren who chose to continue the plan each received half of their share, an amount of $1,111,111.

In the next generation are 27 descendants who each received $3,703,703. Continuing with the third generation where there are 81 descendants, and each one who was satisfied with half received $12,345,679.

An investment of $5,000 at a return of 10% minus 2.25% inflation, initially for 72 years and 3 more 40 year period. At the end of 72 years the tenth multiple is reached after that in each generation, a little less than 6 doublings, meaning in the first generation reached the 16th multiple in the second generation to the 21st multiple and in the third reached the 27th multiple

This is the power of the doublings with the help of the power of time, in the process without adding capital and without increasing the yield.

For an individual, the investment period may seem long, but for each successive generation, the gift is received in real-time. The initial investment's distant starting point is irrelevant to the descendants; they only experience the present value of the gift. The focus is on the future, not the past. In one specific case, an investment of only $5,000 provided gifts to 117 descendants. The investment's value is considered justified even if it only benefits a single individual, regardless of their financial or health situation.

It is important to note that even if some of the beneficiaries retire during the program and it is expected that some will indeed retire, the relative amount that each other descendant will receive will not change. It is possible that one parent has more children and the other has fewer, and then the amount that will be divided between them will be larger or smaller, for the rest it does not matter.

A family program manager hosted a generational gathering for descendants that included showing videos of ancestors, introducing family members, and giving out gifts. Financially, the event was highly successful, turning a $5,000 initial investment into a total of $2,111,100,000. This massive return was distributed among 117 family members, who collectively received $1,111,100,000 in gifts, while $1,000,000,000 was set aside for future program continuation. The cost per descendant for the event was only $42.70.

For example, a multi-generational investment fund may be maintained for 3 generations (e.g., the money may be available at 40 years, 80 years, and 120 years after the initial investment). The initial investment may be locked away by a user e.g., at the beginning of their career for retirement, on the birth of a child for a future family, etc. After 40 years, the money may be “unlocked”, and a portion withdrawn. The withdrawn portion may be divided among family members (e.g., the initial investor, the children of the initial investor, etc.). The remaining money may be reinvested and “locked” away for an additional period. After an additional 40 years, the money may be “unlocked” and a portion withdrawn. The withdrawn portion may be divided among family members (e.g., the initial investor, the children of the initial investor, the grandchildren of the initial investor, etc.). The remaining money may be reinvested and “locked” away for an additional period. After an additional 40 years, the money may be “unlocked” and a portion withdrawn. The withdrawn portion may be divided among family members (e.g., the children of the initial investor, the grandchildren of the initial investor, the great-grandchildren of the initial investor, etc.). The remaining money may be reinvested and “locked” away for an additional period. The cycle could then be repeated to generate multi-generational wealth.

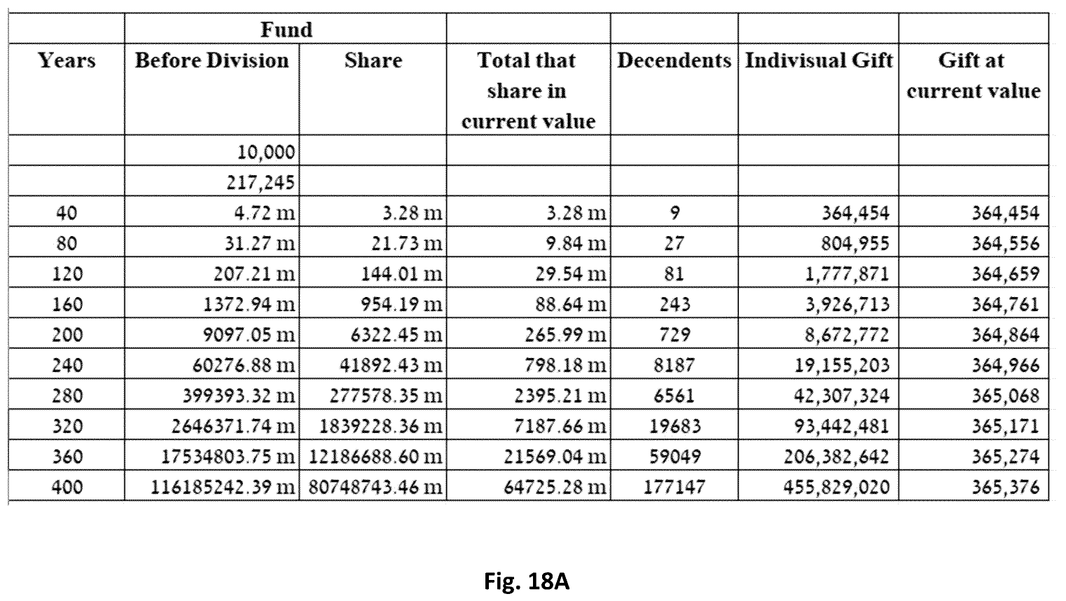

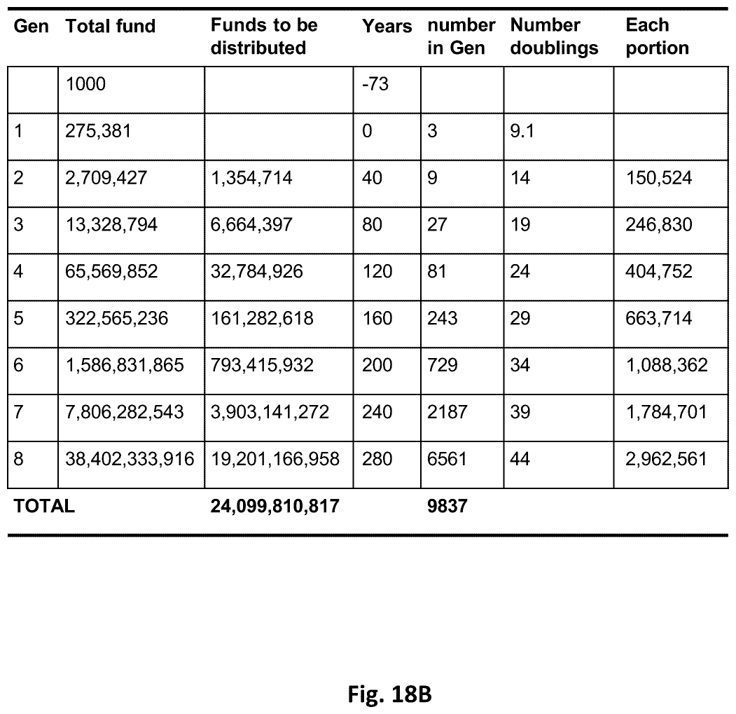

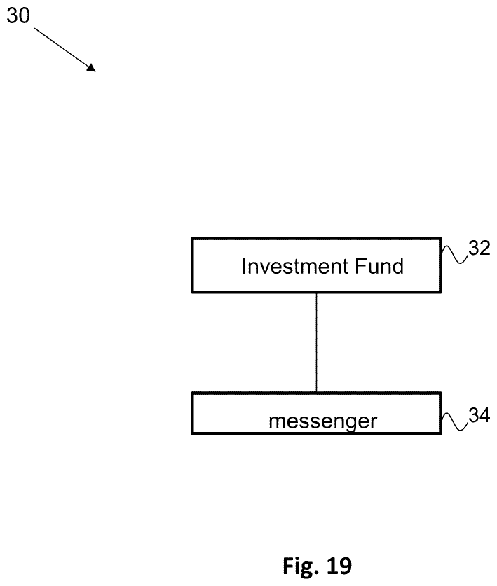

FIG. 18A is a table illustration of creation of a retirement fund by investing one or more “locked” investments at the beginning of a person's career (rather than small amounts throughout their career) or at birth, in accordance with some embodiments. As the investment period increases, the potential number of descendants of the original investor increased by the second generation, the initial investment with have doubled sufficiently to provide multi-generational wealth even when divided among the descendants and/or a portion thereof reinvested.

The system facilitates taking advantage of the time lever and reverses the order-instead of adding years ahead (which is impossible), the plan adds years from behind. Meaning that years are added for offspring—by saving and reinvesting funds for them, at any point in their lifetime, and even before they are born. By doing this, the system allows optimal utilization of the lever of time and the fund may reach its potential. According to the system, the beneficiaries may be the offspring of the initial investor, starting with the next generation. At that point, according to one example embodiment, all the descendants of the family would get, once every 40 years, a gift from the profits of the family fund. The remainder of the money in the fund may continue to generate more profits to be distributed among the second generations descendants, and so on, every 40 years.

The system facilitates investment for the future generation as soon as possible, even before they are born-so that the fund has the time needed to allow the money to grow, using the time lever thereby providing a profit margin large enough to distribute among the beneficiaries, while continuing to reinvest the remainder for an additional 40 years, for the next generation, and so on for the generations after them.

FIG. 18B illustrates a “1,000×” savings plan, in accordance with an embodiment of the current invention. The plan may allow parents to take advantage of the opportunity for their children. Children may in their lifetime reach the tenth factor that may double the amount of money e.g., a parent or from gifts from relatives may increase by 1,000 times, that is, for every deposit with some minimum investment (e.g., between $100 to $500 and/or between $500 to $5000) in their name, in a special trust fund set up and managed for them, may generate an interest rate of around 10% and then when the children reach retirement age in 72 years may receive a sum of 1,000 times the initial investment.

The plan may allow your children to decide already at the age of 65 (e.g., after the 9th doubling yielding approximately 500 times the original amount), upon their retirement, whether to withdraw all or part of the money or continue the deposit until the age of 72 and then they may be able to take advantage of the full power of the tenth doubling and may win a million or more according to the size of the gift amounts invested when they were still babies. Also, this may allow a child to save a lot of money by avoiding taking out of the salary every month for a retirement plan.

The program offers three investment tracks; each track has a different goal.

A route whose goal is to earn about a million dollars in order to comfortably finance the retirement period a route that aims to exempt your children from the need, the possibility and the effort to save money from their salaries for old age.

Instead of saving in any of the following options—to accumulate savings of $1,000,000, Invests $172 for 40 years, a total of $82,560 or invest $470 over 30 years, a total of $169,200 or invest $770 for 25 years, a total of $231,000 or invest $2,000 for 65 years. In some embodiments, the account may be exempt from taxes or allow the beneficiary to direct the amount saved to any other selected purpose.

A surprising proposal for a new route (future present). Combining intergenerational savings or a rolling gift. By investing and reinvesting over a very long period, the initial investment becomes big enough to give a substantial gift to each generation (e.g., starting after two or three generations) and remaining enough principle to continue to give ever increasing gifts to each of one's decedents from generation to generation.

One may open an account for far decedents or may leave a few separate accounts for far and near descendants and/or leave the decision of how much to take and how much to leave for future generations to the future generations. For example, in each generation the parents may decide how much to take and how to leave money to their children and/or future generations. Optionally as long as any parent leaves a portion for his children the investment continues. Alternatively, or additionally, if all of the parents of a generation decide to withdraw all of their money, the investment may stop.

For example, separately deposit an additional $1,000 in the “1,000 times” plan—for a new purpose. For a fund to finance gifts for your descendants from generation to generation.

Additional 40 years of savings

The parent asks/offers each of his children to withdraw for themselves, according to their choice, their relative share of the amount accumulated in the fund or withdraw only half of the amount and leave the other half in the fund to continue the savings.

40 years later, each beneficiary who left at the time half of the amount of the gift he received from his parents. The beneficiary may determine whether to divide the half he left equally among all his children or any other division of his choice.

The beneficiary that chooses to divide the half as a gift to his children, instructs the management company to invest the half he left, as detailed above, in the trust fund, managed by the company, for a period of 40 years.

During the period and even before its end, the father instructs the company how to distribute, on the repayment date at the end of the 40-year period—the money as a gift to all or part of his children, to divide the amounts equally or as he chooses.

The father offered/may ask each of the recipients of the gift to follow the commandment of the founding father and like him, i.e. to decide in due course whether to set aside half, and entrust it again to the company for a period of 40 years as gifts to his children and so on from generation to generation.

The system may operate as long as parents of each generation continue to transfer part of their savings as gifts to their children. When they find a reason to stop the distribution, the system may stop. The yield of the method depends on continuity.

A tenth doubling can only take place if a ninth doubling has taken place and the ninth depends on the eighth and so on, so it is important to prevent the process from stopping by the beneficiary's decision when he reaches maturity to withdraw the money for a purpose other than its original purpose. For example, for a trip after the army or for any other reason.

That is, instead of withdrawing a negligible amount of 10 or even 20 times the deposit must remain on track and accumulate doublings so that he reaches his destination and maximizes the profit up to even 1,000 times.

As already stated, this program aims to manage investments that aim to reach, by utilizing the leverage of time, the tenth multiple. In the hope that good management may shorten the length of the savings period and realize the hope with reasonable chances that the beneficiary with the deposit may have enough in his life to receive the fruits of the deposit and realize the vision of receiving a gift “1,000 times”

In order to realize the vision, two conditions must be met. The first is that the manager of the program may do to the best of his professional ability so that the program progresses at a profitable rate of around 10% per year and the second is that the continuity of the doubling track must be maintained and therefore any external intervention that may stop or disrupt the accumulation process must be prevented before completing the task. Therefore, in order to ensure its proper operation, the parent appointed the representative of the company as a emissary on his behalf and who may be responsible for maintaining the management without interruption until the investment completes the goal of achieving the profit at the expected rate of 1,000 times or when the beneficiary reaches the age of 65, whichever is earlier. Thus, the emissary may complete his duty and transfer the gift, control and responsibility to the owner of the deposit in a timely manner as ordered, who may be able to do with it as he decides from this moment on.

FIG. 19 is a block diagram of an investment fund, in accordance with an embodiment of the current invention. For example, in system 30, an investor hands money to an emissary 34 (which may be a legal firm and/or a rule-based certificate) that locks the money into a compounded interest investment fund 32 for a long time (e.g., 40 to 60 years and/or 60 to 100 years and/or greater than 100 years). In certain emergencies the money may be released early (for example, there may be rules about when to release and/or a human emissary making decisions and/or an automated decision system (e.g., Artificial intelligence). For a relatively small investment, a very large yield is received at the end of the period.

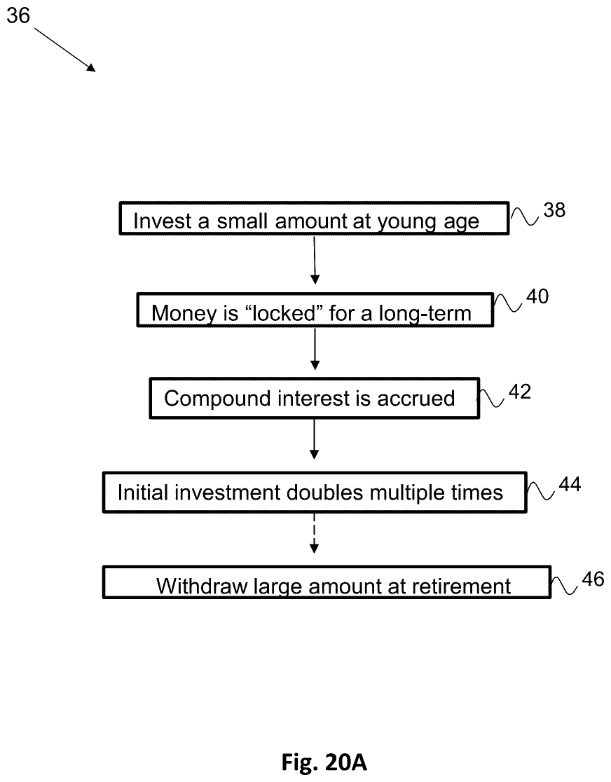

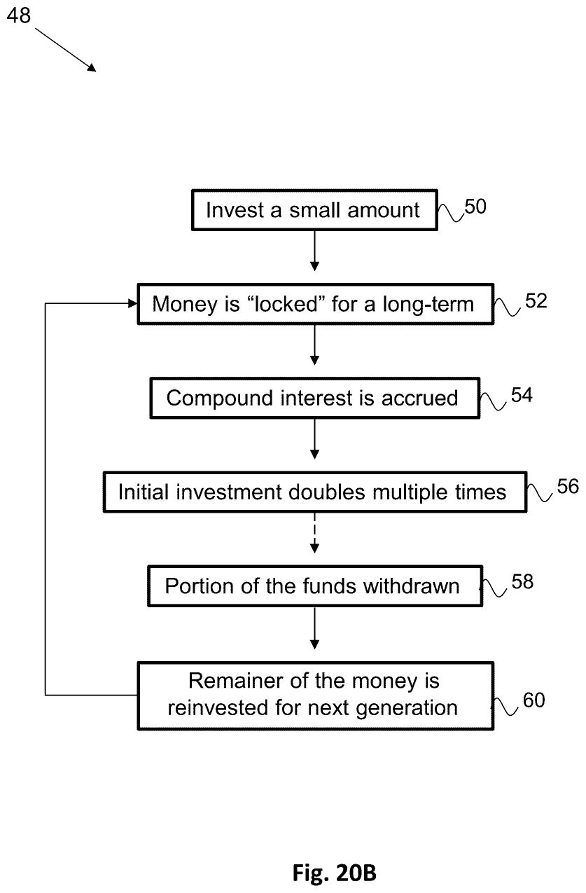

FIG. 20A is a flow chart of a method of creating a retirement account, in accordance with some embodiments of the invention. For example, in method 36, a user invests 38 a small amount of money as an initial investment while he is young. The money is “locked” 40 for a long-term period e.g., it cannot be withdrawn except under extenuating and/or emergency circumstances. Compound interest is accrued 42, such that the initial investment doubles 44 multiple times before the money may optionally be withdrawn 46 (for example at retirement).

FIG. 20B is a flow chart of a method of use, in accordance with some embodiments of the invention. For example, in method 48, a user invests 50 a small amount of money as an initial investment, the money is “locked” 52 for a long-term period e.g., it cannot be withdrawn except under extenuating and/or emergency circumstances. Compound interest is accrued 54, such that the initial investment doubles 58 multiple times before a portion of the money may optionally be withdrawn 58 (for example by the grandchildren of the original investor or for a cause that the investor wanted to open in his name). A portion of the money may continue in the investments account and/or is reinvested 60 and acts as the initial amount on an additional investment period, where the money is “locked”, compound interest is accrued, such that the reinvested initial investment doubles multiple times before a portion of the money may optionally be withdrawn. Optionally, this cycle may be repeated multiple times. Optionally, the amount of money reinvested may be far greater than the initial sum. Optionally, such an investment system may be multi-generational.

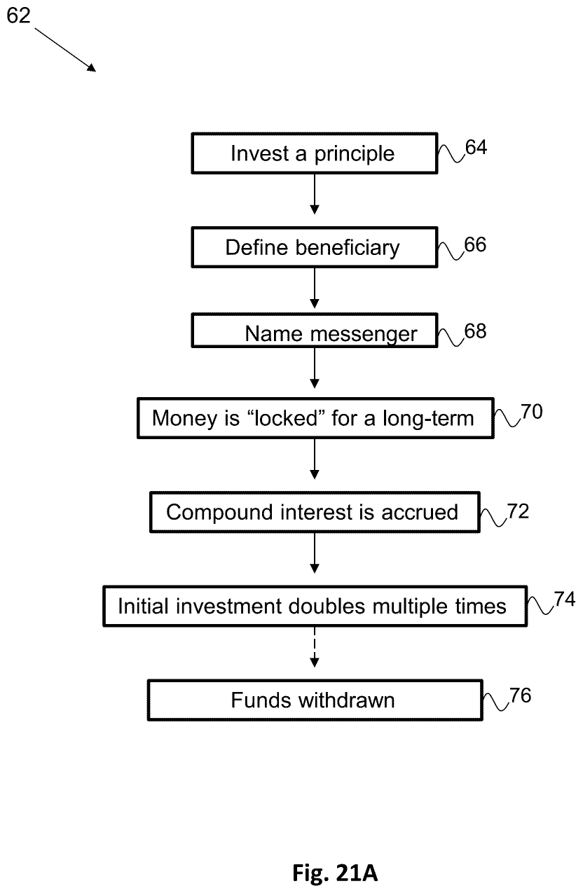

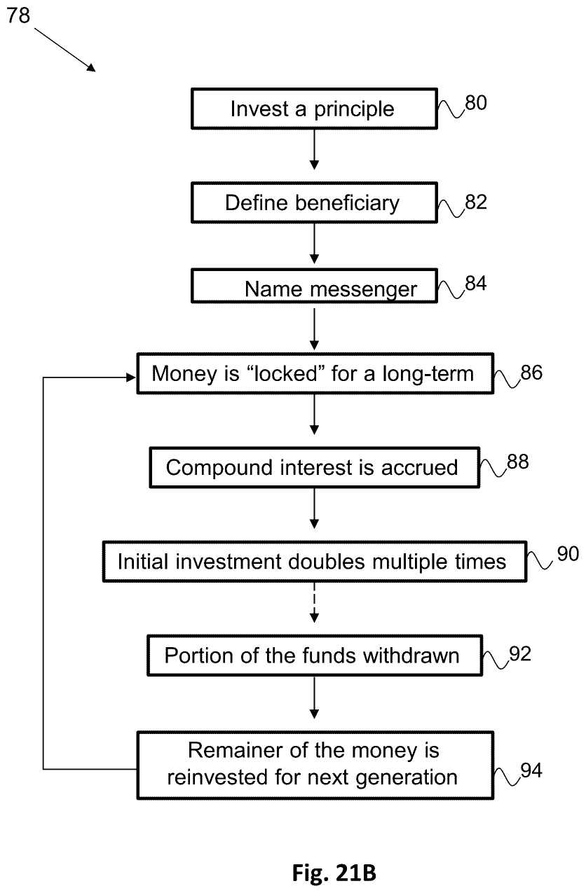

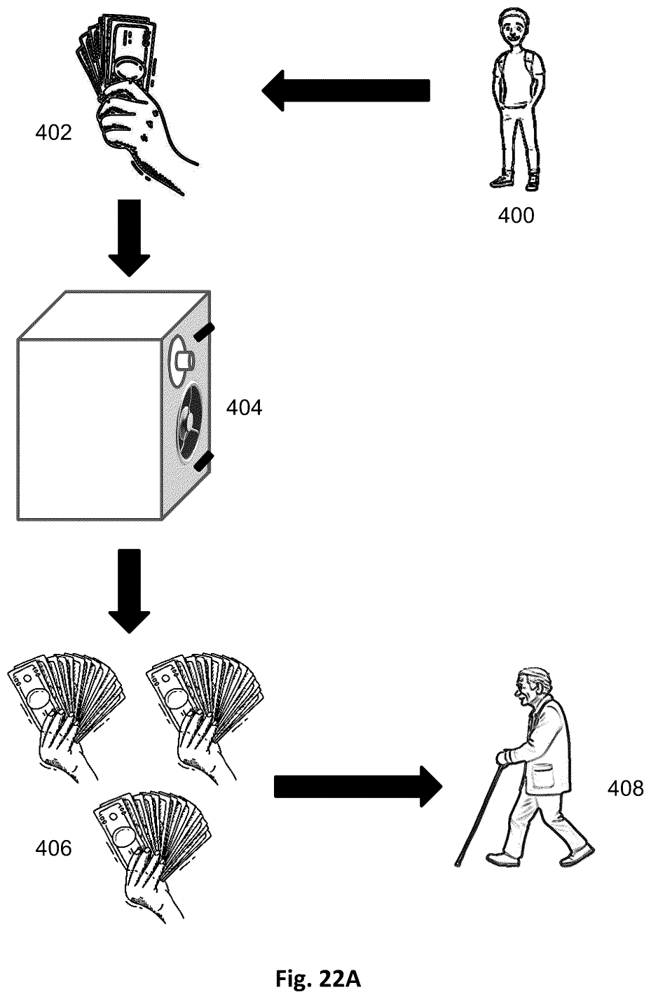

FIGS. 21A-21B are flow diagrams of a method of investing over an extended period, in accordance with some embodiments. For example, in method 62, an initial principle may be invested 64 as a fund. The fund may be set up for a defined 66 beneficiary (who may or may not have been born) and/or a defined organization (that may or may not yet exist) and/or a defined purpose. An emissary (which could include an organization (e.g., a law office, a charitable fund, an investment firm, etc.), and/or an automated system (e.g., a computer program and/or a defined set of rules and/or an artificial intelligence routine)) is named 68 to oversee the handling and/or distribution of the money. Optionally, the money is locked 70 into a compounded interest investment instrument over a long period (e.g., 30 to 50 years and/or 50 to 70 years and/or 70 to 100 years and/or 100 to 200 years or more). Compounded interest is accrued 72. The initial investment doubles 74 multiple times. Optionally at the end of the period some or all of the money is withdrawn 76 and distributed to the intended recipients.

For example, in method 78, an initial principle may be invested 80 as a fund. The fund may be set up for a defined 82 beneficiary (who may or may not have been born) and/or a defined organization (that may or may not yet exist) and/or a defined purpose. An emissary (which could include an organization (e.g., a law office, a charitable fund, an investment firm, etc.), and/or an automated system (e.g., a computer program and/or a defined set of rules and/or an artificial intelligence routine)) is named 84 to oversee the handling and/or distribution of the money. Optionally, the money is locked 86 into a compounded interest investment instrument over a long period (e.g., 30 to 50 years and/or 50 to 70 years and/or 70 to 100 years and/or 100 to 200 years or more). Compounded interest is accrued 88. The initial investment doubles 90 multiple times. At the end of the period a portion of the money is withdrawn 92 and distributed to the intended recipients. The remainer of the money is reinvested 94 for the next generation. Optionally, this cycle may be repeated multiple times.

In some embodiments, the money may be distributed to descendants, there may a set of rules how “descendants” are defined. For example, there may be some requirement of documentation of a genealogy and/or a genetic test and/or certain people (e.g., the founder's currently living descendants) may be allowed to register new descendants and/or the new descendants may be allowed to register further descendants.

In some embodiments, the money may be distributed to qualified individuals (e.g., people who need help, people who are involved in a cause chosen by the founder etc.), there may a set of rules how “qualified individuals” are defined. For example, there may be some requirement of documentation and/or registration and/or certain people (e.g., people currently dedicated to the cause, emissary, trustee, etc.) may be allowed to register new qualified people and/or the new qualified people may be allowed to register further qualified people. Optionally, the fund may be used to influence later generations. For example, the fund may be set aside for any of my descendants that a working for a certain cause in after a defined period of time etc.

In some embodiments, a person may create a fund at a young age and lock away the money, but define the cause at a later age. For example, a young man (e.g., age 20) may lock away money for a period (e.g., 100 years) and then later (e.g., 50 years later when he reaches the age of 70), he may designate is grandchildren as beneficiaries (e.g., when they reach the age of 60 etc.).

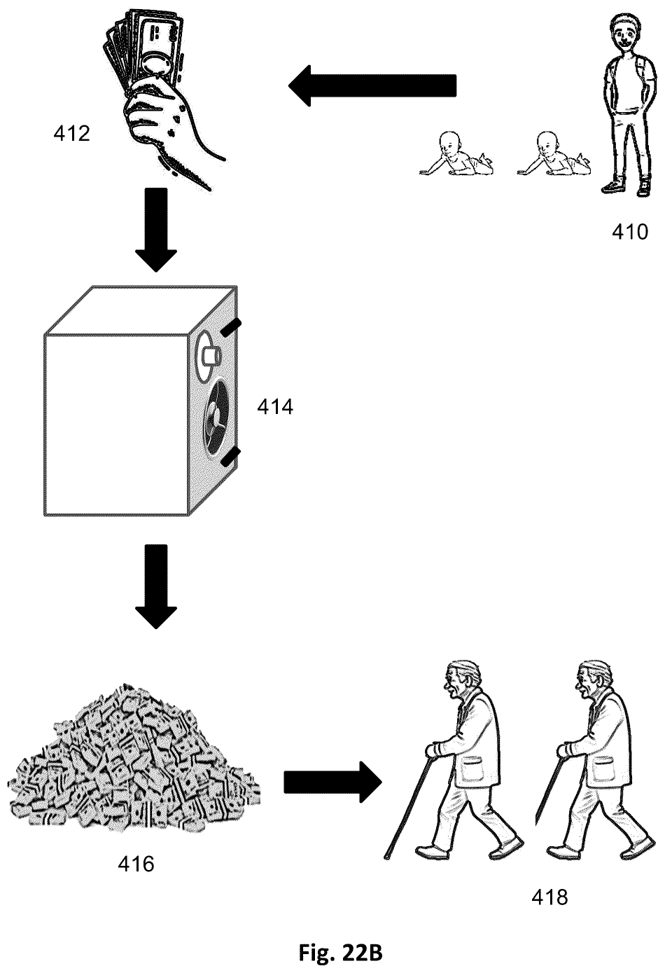

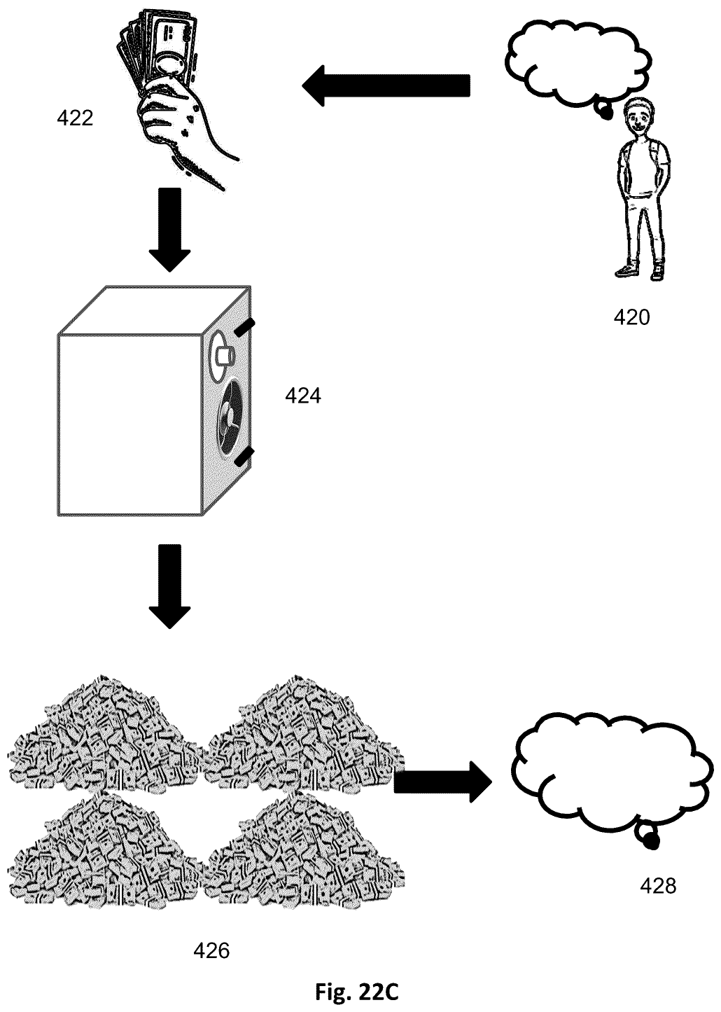

FIGS. 22A-22C are schematic illustrations of various investment plans and/or instruments in accordance with embodiments of the current invention. In some embodiments, a long-term investment instrument in accordance with the current invention may be used by an individual. For example, (e.g., as illustrated in FIG. 22A) a young man 100 (for example at an age between 15 to 25 years old and/or between 25 to 35 years old) may lock 404 away a significant sum of money 402 (e.g., between $1,000 to $10,000 and/or between $100 to $1,000 and/or between $10,000 to $100,000) in a retirement plan for a long period (e.g., between 30 to 50 years and/or between 50 to 70 years). The money may accrue compound interest 406 and he may receive a large pension for his old age 408.

In some embodiments (for example as illustrated in FIG. 22B) a young father 410 may put away money 412 in a closed investment instrument 414 for his children. Even relatively small investment (e.g., between $10 to $500 and/or between $1 to $10 and/or between $500 to $5,000) invested for a long time (e.g., between 50 to 80 years and/or between 80 to 120 years and/or between 120 to 200 years) may build up to a very large sum of money 416 for his children 418 when they retire. Thus, the father by investing a little money up front can help his children later and/or can facilitate them going through their working years without need to pay out much more money to a retirement plan.

In some embodiments (for example as illustrated in FIG. 22C) a person 420 may put away money 422 in a closed investment instrument 424 for some purpose of his dreams. There is a playoff between the time of the investment and the amount invested. Given enough time and interest, even the smallest investment can grow to a huge amount. For example, a person may invest money set aside for his descendants who have not yet been born. For example, a may have a dream to be remembered as a great supporter of charity. He may put away a small amount of money for a very long-term compounded investment and after many years the investment may be worth enough to make a great contribution 426 to a cause 428.

In cases where the original investor may not be alive when the investment comes to term, the oversight of the investment may be carefully arranged (e.g., as described in embodiments above) so that the resulting money really gets to the intended cause in the end.

In some embodiments, the money may be distributed to a qualified organization and/or cause. There may a set of rules how “qualified” is defined. For example, there may be some requirement of documentation and/or registration and/or certain people (e.g., people currently dedicated to the cause, emissary, trustee, etc.) may be allowed to decide new qualified emissaries and/or trustees and/or there may be an automated system (e.g., a computer system and/or an artificial intelligence routine).

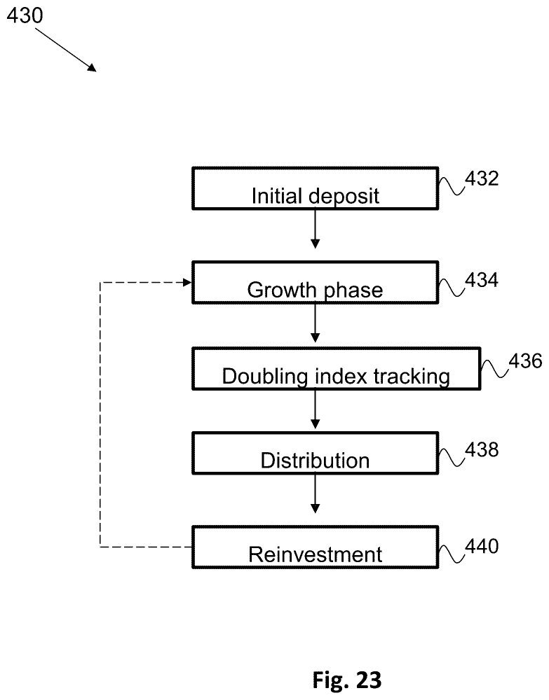

FIG. 23 is a flow chart of a method which may enable long-term intergenerational wealth accumulation and/or distribution, in accordance with some embodiments. For example, method 430 may include an initial deposit 432, e.g., a one-time deposit made by a parent, grandparent, or other entity in favor of a child or family member at birth or another milestone (e.g., marriage). Optionally, the method may include a growth phase (ripening) 434. Optionally, in the growth phase, the investment may be held in a diversified, growth-oriented portfolio (e.g., index-tracking equity funds) and allowed to compound for decades, e.g., with the target of achieving a 1,000-fold increase over approximately 72 years (or 10 doublings). Optionally, the method may include doublings index tracking. Optionally, the method may include doublings index tracking to track 436 investment progress. Optionally, this index may define growth milestones. Optionally, the growth milestones may be defined by the number of times the capital has doubled (producing phase). Optionally, the growth milestones may be defined by duration of investment. Optionally, the growth milestones may be defined by raw return percentages. Optionally, upon reaching a pre-defined milestone (e.g., 10 doublings, 72 years of investment, reaching a pre-dined amount, etc.), a percentage of the funds may be distributed 438 to eligible descendants of the original investor, e.g., 50% of the funds. Optionally, the remaining funds may continue to be invested 440 for another generational cycle (e.g., typically 40 years). Optionally, during the next generational cycle a new list of beneficiaries may be defined by each recipient of the previous cycle. Optionally, a portion of the funds may be reinvested for the next generation. Optionally, a third party may be entrusted to manage the fund according to predefined rules. Optionally, the third party may be an appointed family-appointed emissary, executor, trustee, institutional manager, or Al-based fiduciary. Optionally, the third party may ensure adherence to reinvestment, and/or eligibility, and/or payout criteria. Optionally, the method may include oversight and/or various fund protections. Optionally, a maximum management fee cap may be enforced (e.g., 0.1% annually). Optionally, a family supervisory body and/or trust may review performance and/or adherence to predefined rules. Optionally, the method may include one or more contingency plans to facilitate management replacement in case of risk, and/or breach of trust, and/or financial instability. Optionally, the method may include cycle continuation. Optionally, the process may be repeated by each generation, gradually building family capital over centuries. Optionally, the method may be flexible. Optionally, each cycle may allow full and/or partial withdrawal by each beneficiary. Optionally, each beneficiary may individually decide whether to continue the cycle or to terminate the line of inheritance. Optionally, this method may transform a modest initial investment into an enduring financial legacy.

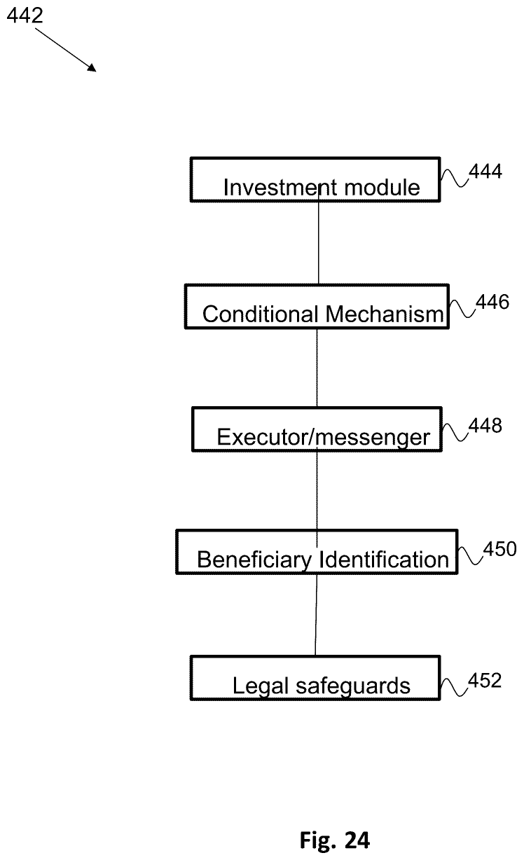

FIG. 24 is a block diagram illustrating a system for multi-generational wealth creation, in accordance with some embodiments. For example, system 442 may include the following components:
Investment Module 444—where the initial amount is invested in index-tracking funds or diversified portfolios.
Conditional Mechanism 446—specifying that funds are to be held until they are multiplied by a pre-defined number of doublings, e.g., at least 1,000.
Executor/Emissary Module 448—enforces the condition and prevents early access using either a human emissary, AI, or an institutional body.
Beneficiary Identification Mechanism 450—identifies future legal heirs or designated individuals at the time of fund release.
Legal Safeguards 452—ensures the arrangement remains valid beyond the depositor's death and cannot be overridden by a standard will.

According to some embodiments, the system may provide a surprise inheritance for great-grandchildren or future generations. Optionally, the system may include future letters of financial intent—messages delivered to the heirs alongside the inheritance. Optionally, the system may facilitate corporate legacy contributions e.g., small funds invested long-term for future societal benefit. Optionally, the system may facilitate integration into national programs and/or philanthropic programs aimed at intergenerational wealth building.

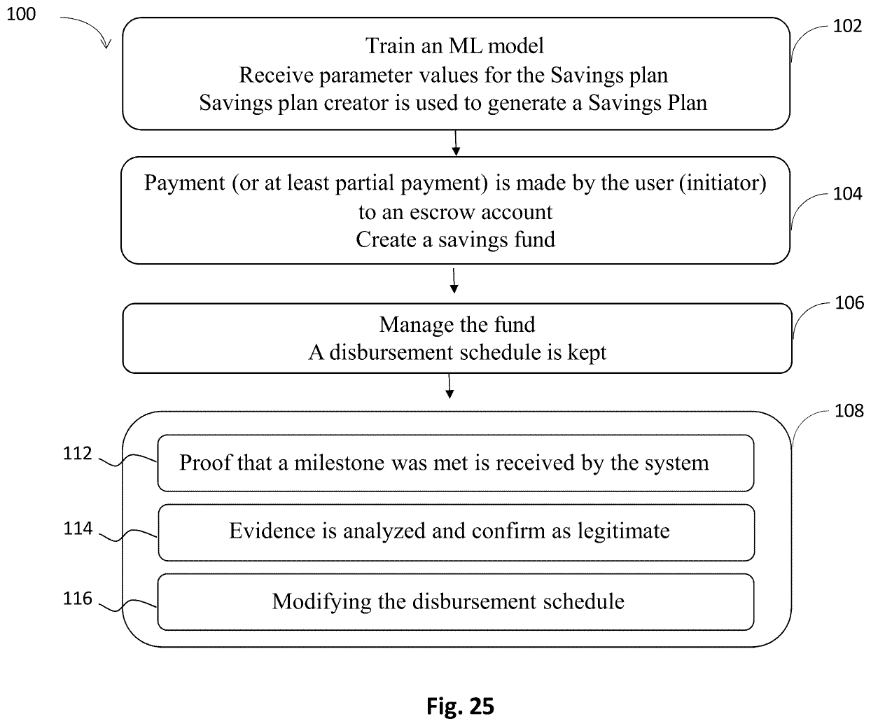

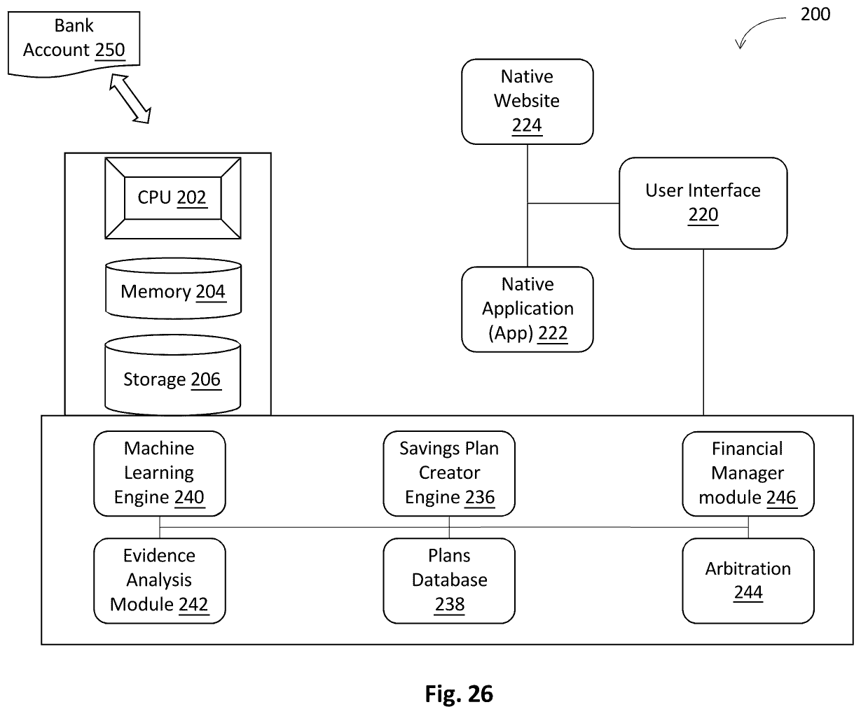

FIG. 25 illustrates a flow diagram 100 of the instant method, in accordance with some embodiments. FIG. 26 illustrates a high-level diagram of specific components included in system 200, in accordance with some embodiments.

An app may be a software application typically installed or loaded on a mobile device such as a smartphone or tablet, but also potentially used on other computing systems such as laptops and desktop computers. A dedicated or system-native app 222 (and the same may be true for a dedicated website 224, such that the following description applies equally to both user interface environments) may be an app (or website) that may be integrally linked to the instant system 200. The dedicated app corresponds to the dedicated website and generally provides the same functionality, as may be well known in the art.

In some example embodiments, whether using a native or non-native website/app, the initiator may be invited to create the fund using the instant system website/app. The website or application requests the necessary information with which to create the savings fund. The terms “savings plan”, “savings fund”, or simply “fund”, as well as variations thereof, are used interchangeably herein. Typically, the fund may be initiated with an initial sum of money and various parameters for the system to use as a guide over the course of the lifetime of the fund.

### Savings Plan Creation

At Step 102, a savings plan creator may be activated via a user interface 220 of the system. The user interface 220 may be embodied in a graphical user interface (GUI) displayed on a computing device such as a desktop/laptop computer, a tablet, smartphone and the like. The users (the user(s) that sets up the plan may be referred to as the initiator, beneficiaries of the fund also provide input to the system) interact with the user interface which may be in communication with the system server (or network of servers, cloud, serverless application, etc.), usually via a network such as the Internet.

In one example embodiment, a non-transitory computer readable medium storing computer-executable instructions that, when executed by a processor, cause a machine learning (ML) engine to train a machine learning model of the machine learning engine using financial datasets. Alternatively, a pretrained model may be imported into the ML engine. In order to generate the plan, the user must provide parameter values. The Savings Plan Creator receives parameter values via a user interface. Then, the Savings Plan Creator generates a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan. (See below for additional details.)

In one example embodiment, the system includes a processing unit (e.g., CPU 202), a memory (e.g., memory 204), and storage (e.g., storage 206). The processing unit executes programs loaded into the memory from storage. The storage 206 stores programs, modules, databases, machine learning engines and the like, as detailed hereafter. A computer program product may include instructions which, when the program may be executed by a computer, cause the computer to carry out the methods described herein. According to some embodiments, the computer implemented method including causing at least one processor (e.g., CPU 202) to execute instructions stored in non-volatile and/or non-transient memory (e.g., storage 206) to perform the steps described herein.

It may be made clear that the hardware, firmware and/or software components, the methods of storage and execution, and the digital and/or graphical representations thereof, are merely examples of non-limiting possibilities for implementing the instant system, i.e., the computer-implemented method may be implemented using any relevant non-transitory computer readable medium storing computer-executable instructions configured to be executed by a processor.

The basic terms and/or parameters of the savings plan are initially set out using the Creator. Some parameters may be changed at a later date (e.g., after a predetermined amount of time has passed and/or a predetermined amount of savings (possibly a relative term, or an absolute number) has accrued. Parameters may include, but are not limited to: the beneficiaries (i.e., by description, as these people may exist in the future, and there may or may not be beneficiaries in the present), the limits for paying out funds, the limits for funds that are to remain in the fund, mitigating factors, exceptions, milestones (e.g., if X amount of savings have accrued, a portion Y of the dividends may be used to create an endowment based on consensus of a predetermined portion of the beneficiaries), manner of dispersion and/or distribution of funds, etc.

The funds are held in, and distributed from, a system financial account 250. The system account 250 may be a single financial account or a plurality of accounts, sub-accounts, connected accounts, etc., in banking and other financial institutions.

The user interface 220 facilitates interaction with a savings plan creator engine 236 adapted to facilitate creation of the plan or retrieval of the plan from an existing saving plans database 238.

Each new plan may be added to the plans database.

It may be made clear that the plan may be generally a set of guidelines by which the system makes decisions on how to invest the money, distribute the money, and maintain a consistent and preferably ever-increasing returns on investment. The decision engine may be an AI based “brain trust” that may be a machine learning (ML) model initially trained on a large dataset and thereafter continues to learn, gather pertinent information, synthesize financial data, and manage the fund. The brain trust makes the investment decisions and also controls the distribution of funds. According to some embodiments, the AI-based system may be both the emissary of the money (accounts, investments, etc.) as well as the arbiter of savings plan.

A machine learning (ML) engine and/or model and/or an Artificial Intelligence (AI) may be model trained on datasets, such as historical financial information, as well as data from the plans database. The AI or AI algorithm may be adapted to create the savings fund based on data provided by the initiator. In some embodiments, the beneficiaries may also provide input into the system via the user interface (or later iterations thereof). For example, the AI and/or ML may draw up the initial savings plan based on the initiator filling out a questionnaire related to parameter values (existing money for investment, family details, etc.) based on prompts generated by the AI/ML engine.

### Funds Held in Third Party Account

In Step 104 payment (or at least partial payment) may be made by the user (initiator) to an escrow account 250 associated with the system. According to some embodiments, the financial account may be an account selected from the group including: a bank account, a cryptocurrency account, and a non-bank account. A non-bank account, as referred to herein, may be any type of account that may not be managed by a bank. There may be a digital wallet, a money transfer application and the like. The account may also, or alternatively, be an account in a financial institution that may be not a bank (a brokerage firm, an investment firm, an insurance company, etc.). The savings plan may be implemented by a financial manager module that creates a savings fund.

The savings plan includes a disbursement schedule which may be based, at least in part, on milestones, the disbursement schedule may be implemented by the financial manager module by disbursing funds to beneficiaries of the savings plan.

In Step 106, a “virtual manager” (e.g., financial manager module that may be driven by the machine learning engine) manages the savings plan. Management of the savings fund includes investing and managing the wealth of the fund and creating and keeping a disbursement schedule. Investing includes making decisions including: where to invest, how much to invest, when to withdraw funds from investments, and combinations thereof.

The disbursement schedule may be updated for each milestone that may be met. According to some embodiments, the disbursement schedule may be managed by a virtual emissary driven by the ML engine. The disbursement schedule includes predetermined payments, or payments determined based on the guidelines of the plan, and/or decisions made by the system. Disbursements are made to the beneficiaries by the system from the escrow account. The beneficiaries are determined based on the achievement of milestones (birth, death, marriage, reaching a predetermined age, and the like). The AI algorithm may be in communication with financial institutions, and receives current financial data therefrom, and wherein the AI algorithm may be continually trained on the current financial data.

In the savings plan and/or guidelines (set up in Step 102) milestones are detailed and defined (e.g., using User Interface 220), including providing details as to what the milestone may be (time passing [e.g., the fund only starts paying out to the second or third generation], monies accrued [e.g., if sufficient money has accrued, then payments may begin, continue, or restart], relative thresholds met [absolute amounts are checked against cost of living etc. to determine relative—but real—value], beneficiary reaching a predetermined age, the etc.). The plan and/or guidelines may also include methods and/or parameters for providing proof that a milestone has been reached, what must be proven and how.

According to some embodiments, the milestones are met based on evidence submitted via the user interface to an Evidence Analysis Module configured to determine if the evidence may be legitimate. For example, milestones may be the birth of a new beneficiary, marriage to a codependent (spouse), death of a beneficiary, a predetermined amount of relative wealth accrued, a predetermined number of times a value of the wealth accrued in the savings fund may be doubled (see “doubling” below), etc. Pictures, documents, etc. may be uploaded to the system which analyzes the “evidence” of the milestone being met and then makes adjustments to the savings fund and/or disbursement schedule accordingly. According to some embodiments, the Evidence Analysis Module may be driven by the ML engine.

In Step 108, the disbursement schedule may be modified for each milestone that may be met, an agreed-upon payment may be forwarded to the beneficiaries from the escrow account, but only upon receipt by the system of proof that the respective milestone was met and confirmation of the legitimacy of the proof. Step 108 may therefore be subdivided into three steps:
Step 112—receipt of proof;
Step 114—analysis of proof; and
Step 116—modifying the disbursement schedule.

The term Disbursement Schedule may be used herein to refer to the amount of funds disbursed to the number of beneficiaries. Both the amount of money as well as the number of beneficiaries may be susceptible to change when a new milestone may be met.

In some embodiments, the user interface 220 may include a sequence of menus and/or pages that the customer and/or provider navigate in order to set up the agreement. A plan Creator Engine 236 may be used to create a savings plan. According to some embodiments, the Plan Creator Engine 236 includes various tools, lists, examples, etc. which the users may use to create a plan which details, for example, milestones, evidence, dispersion schedule, etc. A Plans Database 238 may be a database including predefined plans that users may select from, instead of creating a new plan from scratch. According to some embodiments, existing plans may be modified using the Plan Creator Engine 236. According to some embodiments, plans and/or guidelines created by users are added to the Plans Database 238. Optionally, the AI predictive and/or statistical models may generate the plans based on parameter input by the buyer and/or seller.

A machine learning (ML) engine 240 uses the plans and even the inputs to the plan creator engine as inputs for the AI algorithm 240. The AI algorithm may employ any known artificial intelligence or machine learning model in the art. Alternatively, or additionally, a new model may be trained or an existing model or models may be improved upon. According to some embodiments, the models are pretrained on datasets of financial data, as well as other pertinent data (e.g., data pertaining to the other parameters such as the evidence, arbitration data, etc.). Financial data includes a large array of information. However, in preferred embodiments, the financial data includes investment strategies, historical information of investments and/or savings (e.g., strategies that worked, how they worked, why they worked, patterns of investments and/or contributing factors to the success or failure of investments, savings strategies, high-risk high yield, low-risk low yield, etc.).

The AI models may be pretrained and continuously trained on all datasets relating to the system such that the system may become autonomous with little or no input from human operators and administrators. Training ML models may be aimed at providing a vehicle that may recognize patterns that lead to increased revenue over time and patterns that lead to loss (which should be avoided).

According to some embodiments, the AI algorithm 240 may be used to enhance the Evidence Analysis Module 242. In some embodiments, the Evidence Analysis Module 242 may be autonomously operated by a machine learning (ML) engine that employs artificial intelligence (AI) or ML models to verify the evidence (e.g., birth certificates, death certificates, marriage licenses, court decisions and/or determination of competence and/or incompetence etc.). Evidence Analysis Module 242 may be configured to receive pieces of evidence from beneficiaries as proof of reaching a milestone.

According to some embodiments, the system also serves as an unbiased, objective, arbiter. In cases where conflict or concern arises, one or more beneficiaries may lodge a complaint or appeal against another beneficiary or group of beneficiaries. According to some embodiments, an Arbitration module 244 handles the complaint and analyzes whether the complaint may be justified or not. Some or all of the strategies mentioned with regard to evidence analysis employed here as well. In all cases, the system may refer issues to a human moderator if the automated elements are unable to reach a conclusive decision. This may be particularly relevant for evidence analysis (especially when the system may be relatively new) and appeal adjudication. According to some embodiments, the AI or ML models employ at least one of: computer vision algorithms, prediction models, and statistical models, historical data, current law practices, etc. to analyze the evidence.

In accordance with a disbursement schedule (pre-set and/or determined by the AI based on the guidelines and/or plan), a Financial Manager module 246 sub-system sends instructions to the bank to transfer money from the associated [bank, or other,] account 250 to the beneficiaries. As with other sub-systems, the Financial Manager module 246 may be autonomously operated by AI or, in some cases, forward a decision, or a task, to a human operator. Beneficiaries are, in general, recognized by the system based on milestones (birth, death, marriage, reaching an age, or achievement, etc.). The milestone needs to be met to the satisfaction of various system analysis components.

The phrase “long-term savings” may be intended to indicate that the savings fund may continue to generate wealth and effect disbursement of dividends even after a biological death of an initiator of the savings plan, hopefully for many generations.

The phrase “short-term savings” indicates that the savings plan may generate wealth and effect disbursement of dividends at least during a lifetime of an initiator of the savings plan, and possibly thereafter.

The present system includes, at least, innovative, and dedicated software, e.g., in the form of an application (app) and/or website. Further, the system includes Machine Learning (ML) and/or Artificial Intelligence (AI) components and functionality. The ML and/or AI components are constantly learning the interactions between various datasets of financial knowledge and other quantifiable knowledge bases and how they influence each other. Furthermore, the instant system grows in exponential knowledge by adding each new plan, condition, milestone, definition, etc. to its knowledge base. The activities of different savings funds are all known to the central system, and each new interaction and activity may be collated into the general knowledge of the system and used to improve the various ML models.

That may be to say that, at least, all the interactions that are taking place via the system interface are being used as input to teach the ML and/or AI models and improve their ability to anticipate the needs of the users. The ML and/or AI components are able to guide and/or provide suggestions to initiators and beneficiaries with regards to creation, modification, and/or definitions of plans and/or guidelines, milestones, evidence and the like, based on initial input (training the ML and/or AI models on data sets) as well as ingoing input as the system may be used more. The ML and/or AI models become better and better at reaching conclusions and/or making predictions, as the data sets grow from new input as more and more people use the system and create savings plans, receive evidence, analyze the evidence, etc.

One of the main functions of the instant system may be to hold the money and/or funds in escrow as a virtual emissary and/or virtual trustee. To This end, in the instant example embodiment, a financial server and/or engine handles all the financial aspects of the transactional agreement. The funds may be money, which may be wired between bank accounts, money transferred via payment applications, digital currency such as cryptocurrency, and/or any manner of transferring of funds from one party to a second party (i.e., buyer to seller). Accordingly, the financial server and/or engine may be configured to transfer any type of funds, in any manner, as agreed upon by the parties.

A central server may be the term used herein which may be intended to be representative of any manner of computing arrangement that facilitates the system as described herein. Various computing configurations are well known in the art, and one of skill would know how to implement the present system using any computer arrangement or configuration known in the art. As part of the ever-evolving ML and/or AI “fund manager” and “virtual emissary”, in some embodiments, the system may be adapted to retrieve financial information from financial institutions (banks, the Federal Reserve, stock markets, brokerage house, investment funds, stock exchanges, etc., etc.).

According to embodiments, the AI and/or ML model and/or machine learning engine 240 further drives, augments, and/or assists one or more additional aspects of the system. In a non-limiting list, the ML engine may, according to some embodiments, control or operate and work in conjunction with: the savings plan creator engine 236 (both in generating the questionnaire and in generating the savings plans, the latter being one of the main functions of the AI), the financial manager module 246 (in charge of disbursements (both with the schedule [as defined elsewhere herein] and the practical provision of instructions for transferring of monies), the arbitration module 244, the evidence Analysis Module 242, and even the user interface 220 itself.

Machine Learning and Artificial Intelligence cover a vast range of mechanisms, methods, and techniques. It may be made clear that any type of machine learning model may be used. The term “machine learning (ML)” and grammatical variations thereof may be intended to convey method of machine learning known in the art (e.g., artificial intelligence (AI), deep learning, neural networks, etc.) and/or combinations thereof. One example of a machine learning model may be a neural network. The linkages in a neural network are generally pre-defined. Over some number of training examples, the strength of different relationships emerges by being reflected in the weights of each edge of the neural network as the weights of the edges are adjusted with each training example. In a neural network, an edge exists between two nodes and then over time it may develop a large or small weight reflecting a strong or weak relationship between the variables represented by the two nodes that the edge connects.

Another example embodiment of the machine learning model may be a Convolution Neural Networks (CNN). The instant example may be not intended to limit the method or system in any way, rather it may be merely intended to portray one way of implementing the method and/or system.

Depending on what the ML model may be trained for, the dataset may be used to refine the model's ability to make the best decisions. It may be true that market valuation and financial investment may be a complex science-slash-art. However, training a model on certain aspects of the market may prove to be very successful. Also, following successful investors and investments, investment strategies that have proven themselves over time, and other proven wisdom may arm the model with many reliable tools for creating and/or successfully running a multi-generational savings fund.

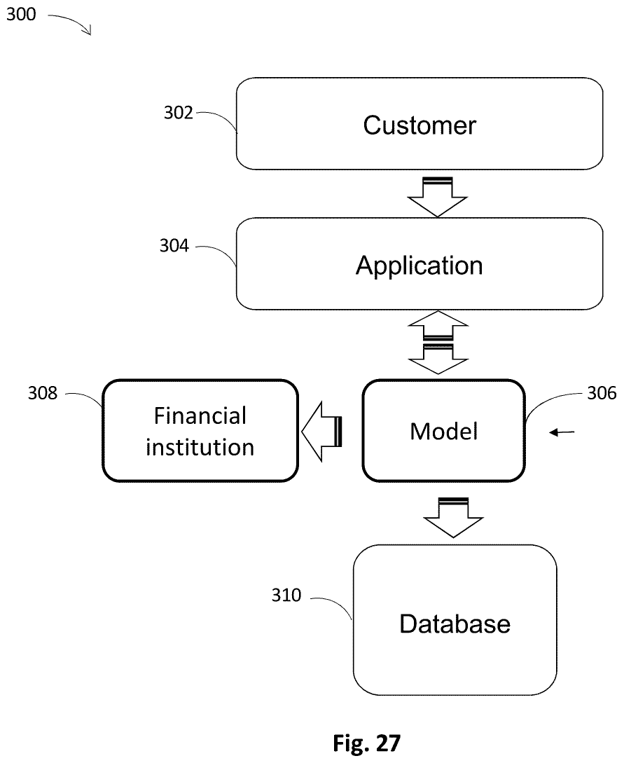

FIG. 27 may be a pictorial flow diagram 300 indicating the high-level components and aspects of the present system and method, in accordance with some embodiments. The first block, 302, indicates a potential customer, such as an initiator, or a user, such as a beneficiary of an existing savings fund. The potential customer or user interfaces with the system via the GUI of a website or application 304. The initiator and/or user may set up the fund by defining the parameters of the multi-generational savings instrument, or by tweaking the parameters of an existing plan (e.g., selected from the plans database 238). A beneficiary may interact with a “live” fund via the website and/or app, e.g., to inform the system of one or more milestones.

The heart of the system may be the AI and/or ML model 306 embedded in the system software. The AI and/or ML model may be initially trained on supervised datasets of, inter alia, investment planning, until the system may be able to generate a plan based on basic parameters. The AI and/or ML model continues to learn and expand its knowledge base and improve its investment, savings, and wealth generation capabilities. The AI continues to optimize the fund plan as the knowledge grows and may be refined. The knowledge may be gleaned from the fund itself (what investments succeeded, which failed, various degrees of each, etc.), from other funds that run on the same system but have different parameters, and from ongoing information from external sources.

To the latter end, in some embodiments, the system may be connected to, or in communication with, banking and other financial institutions 308 locally and possibly internationally, including, but obviously not limited to, stock markets, exchanges, investment houses, central banks, pension funds, insurance companies, etc.

The AI and/or ML model may be both trained on, and continually in communication with financial accounting knowledge bases 310. These knowledge bases include methods, approaches, and accounting systems that are known and documented. Uniquely, the knowledge base of the inventor, Nachum Eshel, may be also part of the training dataset with which the AI and/or ML model may be trained.

According to embodiments, the AI and/or ML model may be trained on a supervised dataset and configured to generate a financial plan for a savings fund that may propagate over more than a single generation and continue to generate wealth and disburse dividends even after the biological death of the initiator or initiators.

These embodiments are provided by way of example and are in no means intended to limit the scope of the invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

### General

It is expected that during the life of a patent maturing from this application many relevant building technologies, artificial intelligence methodologies, computer user interfaces, image capture devices may be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, may control. In addition, the materials, methods, and examples are illustrative only and are not intended to be necessarily limiting.

As may be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It may be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

The term “long-term” as used herein relates to periods of time greater than 40 years.

The term “doubling time” as used herein relates to the amount of time required for an amount to double itself solely through accrued interest and/or compound interest.

The term “doubling” as used herein relates to an amount which has doubled itself solely through accrued interest and/or compound interest.

As used herein the term “about” refers to +10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

As used herein, the terms “plurality”, “multiple” and “multi” are used interchangeably, and mean one or more, e.g., 1, 2, 3, 4, 5, 10, 20, etc.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations may be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for intergenerational wealth accumulation and management, the method comprising:
receiving an initial investment from a user;
locking the initial investment in a financial account for a predetermined period of time;
accruing compound interest on the initial investment during the predetermined period of time;
determining if predefined conditions for early withdrawal are met, wherein the predefined conditions include emergency circumstances;
reinvesting the compound interest accrued on the initial investment;
preventing access to compound interest, that has been accrued, until occurrence of predefined milestones, wherein the predefined milestones include at least one of the following: a predetermined amount of interest accrued, a predetermined amount of money accrued, a predetermined amount of time elapsed, or a predetermined number of doublings of the investment;
upon reaching one of the predefined milestones, disbursing a portion of compound interest, that has been accrued, to designated beneficiaries while reinvesting the remaining portion for future growth; and
managing the financial account using an artificial intelligence (AI) algorithm, wherein the AI algorithm is trained on financial datasets and continually updated with current financial data to optimize investment decisions.

2. The method of claim 1, further comprising:
allowing the user to define an initial investment amount, wherein the initial investment amount can be a single lump sum or a series of periodic deposits.

3. The method of claim 1, wherein the predefined conditions for early withdrawal include at least one of the following: medical emergency, ongoing medical treatment, bankruptcy, war, terror attacks, or purchasing a house.

4. The method of claim 1, further comprising:
designating a third party to oversee the management of the financial account, wherein the third party is selected from an emissary, executor, trustee, steward, financial institution, or an AI algorithm.

5. The method of claim 1, further comprising:
consulting with the user or a descendant thereof to define the amount to withdraw and/or to redefine conditions for future withdrawal.

6. The method of claim 1, wherein the AI algorithm includes a machine learning engine that generates a savings plan based on provided parameter values, the savings plan including a disbursement schedule based on milestones.

7. The method of claim 1, further comprising:
preventing early withdrawal based on a contract and/or escrow agreement.

8. The method of claim 1, wherein the financial account is managed by the AI algorithm, and the management includes making decisions on where to invest, how much to invest, and when to withdraw funds from investments.

9. A system for legacy savings, the system comprising:
a first sub-system configured to receive an initial investment amount from a user;
a second sub-system configured to lock the initial investment amount for a predetermined period in an investment fund, preventing early withdrawal except under predefined conditions;
a third sub-system configured to accrue compound interest on the initial investment amount over the predetermined period;
a fourth sub-system configured to determine when the initial investment amount has doubled a predefined number of times;
a fifth sub-system configured to facilitate withdrawal of a portion of the compound interest, that has been accrued, upon meeting the predefined conditions or a predefined number of doublings;
a sixth sub-system configured to reinvest any remaining portion of compound interest, that has been accrued, for an additional investment period;
a seventh sub-system configured to manage the investment and reinvestment process using an artificial intelligence (AI) algorithm; and
an eighth sub-system configured to distribute funds to beneficiaries based on a disbursement schedule driven by the AI algorithm and predefined milestones.

10. The system of claim 9, wherein the first sub-system is further configured to receive the initial investment amount at any time, including at birth of a child, marriage, or after a windfall.

11. The system of claim 9, wherein the predefined conditions for early withdrawal include emergency circumstances such as medical emergencies, ongoing medical treatment, bankruptcy, war, terror attacks, or purchasing a house.

12. The system of claim 9, wherein the AI algorithm is configured to continually train on current financial data received from financial institutions to optimize an investment strategy.

13. The system of claim 9, wherein the disbursement schedule includes milestones such as a predetermined amount of relative wealth accrued, a birth or death of a beneficiary, or a predetermined number of times a value of the wealth accrued in the investment fund is doubled.

14. The system of claim 9, wherein the sixth sub-system is further configured to allow each generation to withdraw a percentage of the investments and reinvest or maintain a percentage of the investments for future generations.

15. The system of claim 9, wherein the AI algorithm manages the investment fund by making decisions including where to invest, how much to invest, when to withdraw funds from investments, and combinations thereof.

16. The system of claim 9, wherein the seventh sub-system includes a non-transitory computer-readable medium storing computer-executable instructions that, when executed by a processor, cause the AI algorithm to train a machine learning model using financial datasets to generate and manage investment.

17. An investment system for multi-generational wealth creation, comprising:
an investment module configured to invest an initial investment for an initial investor in index-tracking funds or a diversified portfolio;
a conditional mechanism configured to determine if a pre-defined parameter has been fulfilled;
a emissary module configured to enforce the conditional mechanism; and
a beneficiary identification mechanism configured to identify legal heirs or designated individuals when the pre-defined parameter has been fulfilled.

18. The system according to claim 17, wherein the pre-defined parameter includes reaching a pre-defined growth milestone, a pre-defined number of doublings of the initial investment, a pre-defined amount, a pre-defined duration of investment, a raw return percentage, emergency circumstances, extenuating circumstances, or a combination thereof.

19. The system according to claim 17, wherein the beneficiary includes one or more of a descendant of the initial investor, an individual designated by the initial investor, an organization, or a purpose.

20. The system according to claim 17, wherein the emissary is selected from one or more of an organization, a law office, a charitable fund, an investment firm, an automated system, or an artificial intelligence (AI) model.
